(19) United States
(12) Patent Application Publication
(10) Pub. No.: US 2018/0314176 A1
(43) Pub. Date: Nov. 1, 2018

(54) TONER AND TONER MANUFACTURING METHOD

(71) Applicant: CANON KABUSHIKI KAISHA, Tokyo (JP)

(72) Inventors: Megumi Ikeda, Kashiwa-shi (JP); lchiro Kanno, Kashiwa-shi (JP); Akifumi Matsubara, Narashino-shi (JP); Hitoshi Sano, Matsudo-shi (JP); Yuto Onozaki, Saitama-shi (JO); Takeshi Hashimoto, Moriya-shi (JP); Masayuki Hama, Toride-shi (JP); Nozomu Komatsu, Toride-shi (JP); Takakuni Kobori, Toride-shi (JP); Hiroyuki Fujikawa, Yokohama-shi (JP)

(21) Appl. No.: 15/955,291

(22) Filed: Apr. 17, 2018

(30) Foreign Application Priority Data
Apr. 28, 2017 (JP) 2017-089856
Mar. 23, 2018 (JP) 2018-055535

(51) Int. Cl. G03G 9/09; G03G 9/087; G03G 9/08

(52) U.S. Cl. CPC G03G 9/092; G03G 9/08755; G03G 9/0926; G03G 9/081; G03G 9/08728

(57) ABSTRACT

Provided is a toner having a toner particle including a binder resin and a colorant, wherein the colorant includes a compound represented by Formula (1) below, a crystal of the compound in the toner particle has a diffraction peak with a full width at half maximum of at least 0.400° and not more than 0.440° in a range of a diffraction angle 2θ of at least 5.0° and not more than 6.0° in an X-ray diffraction spectrum using CuKα rays,

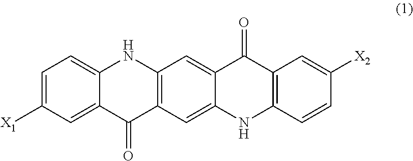

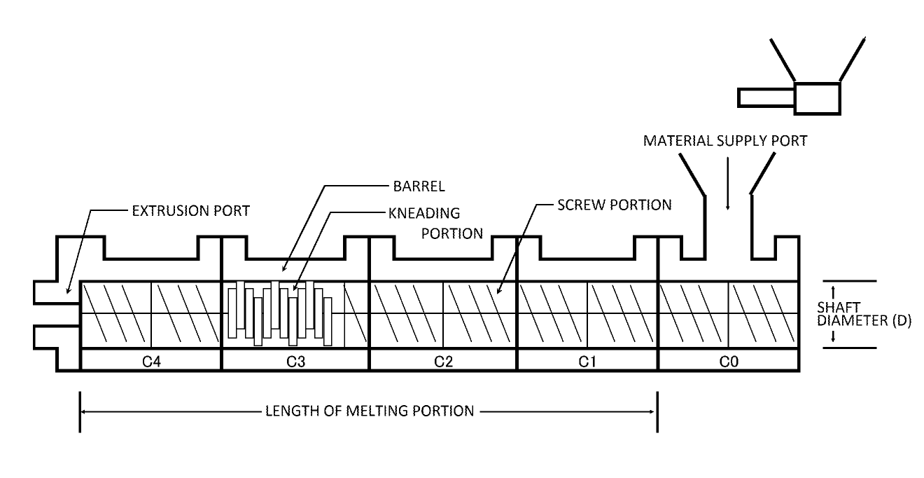

in Formula (1), X₁ and X₂ each independently represent a hydrogen atom, a chlorine atom or a methyl group.

### BACKGROUND OF THE INVENTION

### Field of the Invention

The present invention relates to a toner to be used for an electrophotographic method, an electrostatic recording method, an electrostatic printing method, a toner jet method, or the like.

### Description of the Related Art

In recent years, a demand for higher image quality has been growing following the development of color image forming techniques based on the electrophotographic method. In order to achieve high image quality, it is important to improve the dispersibility of a pigment in a toner particle and to maximize the coloring performance of the pigment in the toner particle.

In general, organic pigments are excellent in chromogenecity and lightfastness, but are poorly dispersed in a toner particle as compared with inorganic pigments. Therefore, studies have been conducted to increase the primary particle diameter of the pigment in order to enhance the dispersibility of the organic pigment, but where the primary particle diameter of the pigment is increased, it is difficult to sufficiently exert the coloring performance of the pigment.

In particular, a quinacridone pigment in a magenta toner has extremely high crystallinity, and the primary particles of the pigment tend to aggregate with one another, so that the dispersibility in the toner particles is low, a changing in tinges is likely to occur, and sufficient coloring performance cannot be exhibited. However, since the quinacridone pigment is an organic pigment excellent in organic solvent resistance and lightfastness, a technique for dispersing the quinacridone pigment in a toner particle is required.

Accordingly, a method using a pigment dispersant and a technique of making a master batch of a pigment in advance have been suggested as a technique for uniformly dispersing the quinacridone pigment in a binder resin.

For example, Japanese Patent Application Publication No. 2006-323414 suggests a technique of adding a compound having a structure in which a quinacridone-based molecular skeleton and an oligomer or a polymer having a high affinity for a resin serving as a toner binder are covalently bonded to enhance the dispersibility of a quinacridone pigment.

Further, Japanese Patent Application Publication No. 2008-285649 suggest a technique of mixing a quinacridone pigment and a resin to carry out a master batch forming step.

### SUMMARY OF THE INVENTION

However, none of these methods can be said to be sufficient to exhibit the coloring performance of the pigment to the maximum, and it is necessary to develop a toner that excels in high image quality and tinge stability, and also excels in the dispersibility of a quinacridone pigment having a small primary particle diameter.

An object of the present invention is to provide a toner which solves the abovementioned problems. Specifically, an object of the present invention is to provide a toner excellent in high image quality and tinge stability.

The present invention relates to

a toner having a toner particle including a binder resin and a colorant, wherein

the colorant includes a compound represented by Formula (1) below, and

a crystal of the compound in the toner particle has a diffraction peak with a full width at half maximum of at least 0.400° and not more than 0.440° in a range of a diffraction angle 2θ of at least 5.0° and not more than 6.0° in an X-ray diffraction spectrum using CuKα rays.

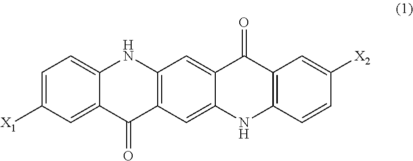

(In Formula (1), X₁ and X₂ each independently represent a hydrogen atom, a chlorine atom or a methyl group.)

According to the present invention, it is possible to provide a toner excellent in high image quality and tinge stability.

Further features of the present invention will become apparent from the following description of exemplary embodiments with reference to the attached drawing.

### BRIEF DESCRIPTION OF THE DRAWING

The FIGURE shows an example of a twin-screw kneader.

### DESCRIPTION OF THE EMBODIMENTS

In the present invention, the expression “at least AA and not more than BB” and “AA to BB” representing a numerical range mean, unless otherwise specified, a numerical range including a lower limit and an upper limit which are endpoints.

The term “monomer unit” refers to a reacted form of a monomer substance in a polymer.

Further, the crystalline resin is a resin in which an endothermic peak is observed in differential scanning calorimetry (DSC).

The toner of the present invention is

a toner having a toner particle including a binder resin and a colorant, wherein

the colorant includes a compound represented by Formula (1) above, and

a crystal of the compound in the toner particle has a diffraction peak with a full width at half maximum of at least 0.400° and not more than 0.440° in a range of a diffraction angle 2θ of at least 5.0° and not more than 6.0° in an X-ray diffraction spectrum using CuKα rays.

By controlling the properties of the compound as described above, it is possible to obtain a toner excellent in pigment dispersibility in a toner particle and also excellent in high image quality and tinge stability.

A method for controlling the state of dispersion of a quinacridone pigment, which is a colorant mainly used for magenta toner, in a toner particle is considered hereinbelow.

The inventors of the present invention focused their attention on the structure and crystal state of quinacridone and found that a toner excellent in tinge stability can be obtained by controlling the crystal state.

Specifically, it is thought that such a toner can be obtained by controlling the crystallite diameter of the crystal of the compound represented by Formula (1) (hereinafter also simply referred to as the compound (1)) in the toner particle.

The crystallite diameter represents the size of a minimum microcrystalline unit and can be calculated from the full width at half maximum of the diffraction peak derived from the crystal of the compound (1) obtained by X-ray diffraction analysis.

The full width at half maximum is a peak width at an intensity which is half the diffraction peak intensity. The diffraction peak becomes sharper and the full width at half maximum becomes smaller as the crystallite diameter increases.

Therefore, the crystallite diameter of the compound (1) in the toner particle can be controlled by setting the full width at half maximum of the diffraction peak obtained by X-ray diffraction within the abovementioned range.

The full width at half maximum of the diffraction peak is at least 0.400° and not more than 0.440°. Further, the full width at half maximum is preferably at least 0.410° and not more than 0.430°, and more preferably at least 0.415° and not more than 0.425°.

When the full width at half maximum of the diffraction peak is less than 0.400°, since the crystallite of the compound (1) has grown too much, the interaction between the compounds (1) increases, the state of dispersion in the toner particle is not sufficient, and the tinge stability is lowered.

Meanwhile, when the full width at half maximum of the diffraction peak exceeds 0.440°, the crystallinity of the compound (1) in the toner particle collapses and the chromogenecity decreases.

For example, a method of adding a compound that effectively acts on strains between molecules of the compound (1) and further applying a mechanical shearing force or shear can be used to control the crystallite diameter of the compound (1) in the toner particle.

In the conventional toner, since the crystal growth property of the compound (1) is strong, it is difficult to suppress a large growth of the crystallite diameter of the compound (1) in the process of producing toner particles.

However, by adding a compound having a crystallite diameter different from that of the compound (1), for example, a crystalline polyester resin, in the process of producing toner particles, it is possible to induce the interaction of the compound (1) and the crystalline polyester resin and weaken the crystal growth property of the compound (1). Further, as a result of applying a strong mechanical shear force or shear to the compound (1), the compound (1) can be included in the toner particle while maintaining a desired crystallite diameter.

From the viewpoint of dispersibility of the pigment and improvement of tinge stability of the toner, it is preferable that the toner particle include a compound represented by Formula (2) below (hereinafter also simply referred to as compound (2)).

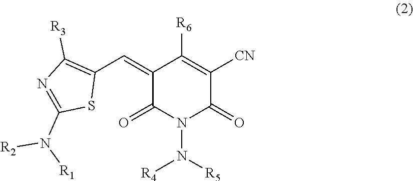

(In Formula (2), R₁, R₂, R₃ and R₆ each independently represent an alkyl group or an aryl group, R₄ and R₅ each independently represent an aryl group, an acyl group or an alkyl group, or represent a cyclic organic functional group in which R₄ and R₅ are bonded to each other and which includes R₄, R₅, and a nitrogen atom to which R₄ and R₅ are bonded at the same time.)

In Formula (2), the alkyl group in R₁ and R₂ is not particularly limited, and examples thereof include saturated or unsaturated, linear, branched or cyclic primary to tertiary alkyl groups having 1 to 20 carbon atoms, such as a methyl group, an ethyl group, an n-propyl group, an iso-propyl group, an n-butyl group, a sec-butyl group, a tert-butyl group, an octyl group, a dodecyl group, a nonadecyl group, a cyclobutyl group, a cyclopentyl group, a cyclohexyl group, a methylcyclohexyl group, a 2-ethylpropyl group, a 2-ethylhexyl group, a cyclohexenylethyl group, and the like.

In Formula (2), the aryl group in R₁ and R₂ is not particularly limited, and examples thereof include an unsubstituted phenyl group and a substituted phenyl group having 6 to 10 carbon atoms. Examples of the substituent include an alkyl group, an alkoxy group, and the like. Where a substituent is present, the number of carbon atoms represents the number including the number of carbon atoms in the substituent. Further, one or a plurality of substituents may be used. Specific examples of the unsubstituted phenyl group and a substituted phenyl group having 6 to 10 carbon atoms include a phenyl group, a 4-methylphenyl group, a 4-methoxyphenyl group, and the like.

In Formula (2), R₁ and R₂ are particularly compatible with the binder resin when a branched alkyl group such as a 2-ethylhexyl group is used, and such a group is preferred because the sharp melting property of the toner which is due to the crystalline polyester is enhanced.

In Formula (2), the alkyl group in R₆ is not particularly limited, and examples thereof include alkyl groups having 1 to 20 carbon atoms, such as a methyl group, an ethyl group, an n-propyl group, an iso-propyl group, an n-butyl group, an iso-butyl group, a 2-methylbutyl group, a 2,3,3-trimethylbutyl group, an octyl group, and the like.

In Formula (2), the aryl group in R₆ is not particularly limited, and examples thereof include aryl groups having 6 to 10 carbon atoms, such as a phenyl group, a methylphenyl group, a methoxyphenyl group, and the like.

In Formula (2), it is preferable that R₆ be an alkyl group such as a methyl group, an n-butyl group, a 2-methylbutyl group, a 2,3,3-trimethylbutyl group or the like, because the compatibility with the binder resin is improved, the dispersibility of the compound (1) is improved and the charge stability of the toner is enhanced.

In Formula (2), the alkyl group in R₃ is not particularly limited, and examples thereof include a primary to tertiary alkyl group having 1 to 20 carbon atoms, such as a methyl group, an ethyl group, an n-propyl group, an iso-propyl group, an n-butyl group, a sec-butyl group, a t-butyl group, and the like. It is particularly preferable that R₃ be a t-butyl group, which is a tertiary alkyl group, because the dispersibility of the compound (1) is improved and the charge stability of the toner is enhanced.

In Formula (2), the aryl group in R₃ is not particularly limited but, for example, a structure represented by Formula (3) below is preferable.

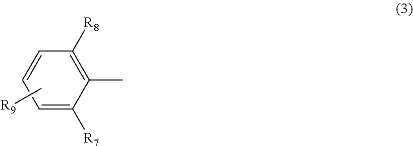

In Formula (3), R₇, R₈ and R₉ represent a hydrogen atom, an alkyl group, or an alkoxy group.

The alkyl group in R₇ and R₈ is not particularly limited, and examples thereof include an alkyl group having 1 to 4 carbon atoms, such as a methyl group, an ethyl group, an n-propyl group, an iso-propyl group, an n-butyl group, and the like, and among them, a methyl group is preferred.

The alkoxy group in R₇ and R₈ is not particularly limited, and examples thereof include an alkoxy group having 1 to 4 carbon atoms such as a methoxy group, an ethoxy group, an n-propoxy group, an i-propoxy group, an n-butoxy group, an i-butoxy group, a sec-butoxy, a tert-butoxy group, and the like.

In Formula (3), the alkyl group in R₉ is not particularly limited, and examples thereof include a saturated or unsaturated, linear, branched or cyclic primary to tertiary alkyl group having at least 1 and not more than 20 carbon atoms, such as a methyl group, an ethyl group, an n-propyl group, an iso-propyl group, an n-butyl group, a sec-butyl group, a tert-butyl group, an octyl group, a dodecyl group, a nonadecyl group, a cyclobutyl group, a cyclopentyl group, a cyclohexyl group, a methylcyclohexyl group, a 2-ethylpropyl group, a 2-ethylhexyl group, a cyclohexenylethyl group, and the like.

In Formula (3), the alkoxy group in R₉ is not particularly limited, and examples thereof include an alkoxy group having 1 to 20 carbon atoms such as a methoxy group, an ethoxy group, an n-propoxy group, an i-propoxy group, an n-butoxy group, an i-butoxy group, a sec-butoxy group, a tert-butoxy group and the like.

In Formula (2), the alkyl group in R₄ and R₅ is not particularly limited, and examples thereof include a saturated or unsaturated, linear, branched or cyclic primary to tertiary alkyl group having at least 1 and not more than 20 carbon atoms, such as a methyl group, an ethyl group, an n-propyl group, an iso-propyl group, an n-butyl group, a sec-butyl group, a tert-butyl group, an octyl group, a dodecyl group, a nonadecyl group, a cyclobutyl group, a cyclopentyl group, a cyclohexyl group, a methylcyclohexyl group, a 2-ethylpropyl group, a 2-ethylhexyl group, a cyclohexenylethyl group, and the like.

In Formula (2), the acyl group in R₄ and R₅ is not particularly limited, and examples thereof include a formyl group, a substituted or unsubstituted alkylcarbonyl group having at least 2 and not more than 30 carbon atoms, a substituted or unsubstituted arylcarbonyl group having at least 7 and not more than 30 carbon atoms, and a heterocyclic carbonyl group. Specific examples thereof include an acetyl group, a propionyl group, a pivaloyl group, a benzoyl group, a naphthoyl group, a 2-pyridylcarbonyl group, a 2-furylcarbonyl group, and the like.

In Formula (2), the aryl group in R₄ and R₅ is not particularly limited, and examples thereof include a substituted or unsubstituted aryl group having at least 6 and not more than 10 carbon atoms. Examples of the substituent include an alkyl group, an alkoxy group, and the like. Where a substituent is present, the number of carbon atoms represents the number including the number of carbon atoms in the substituent. Further, one or a plurality of substituents may be used. Specific examples thereof include a phenyl group, a 4-methylphenyl group, a 4-methoxyphenyl group, and the like.

In Formula (2), the cyclic organic functional group in which R₄ and R₅ are bonded to each other and which includes R₄, R₅, and a nitrogen atom to which R₄ and R₅ are bonded at the same time, is not particularly limited, and examples thereof include a piperidinyl group, a piperazinyl group, a morpholinyl group, and the like.

In Formula (2), it is particularly preferred that at least any one of R₄ and R₅ be an alkyl group because compatibility with the binder resin is improved, dispersibility of the compound (1) is improved, and charge stability of the toner is improved.

In particular, where at least any one of R₄ and R₅ is a methyl group, the dispersibility of the compound (1) and the charge stability of the toner are excellent.

The compound (2) according to the present invention can be synthesized with reference to a publicly known method disclosed in WO 92/19684.

An embodiment of a method for producing the compound (2) is described below, but the production method is not limited thereto.

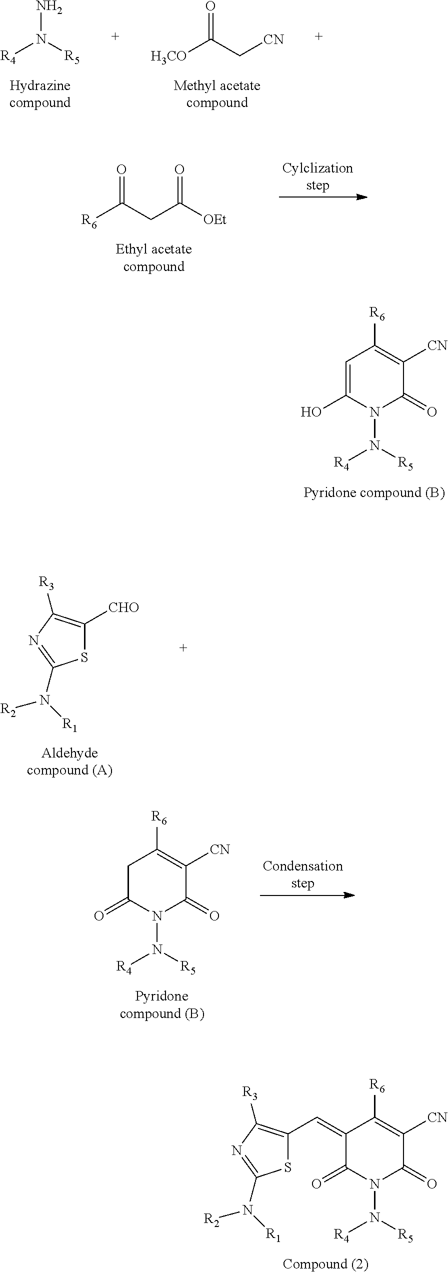

R₁ to R₆ in the compounds in the reaction formulas hereinabove and in the compound (2) have the same meanings as those described above. Further, the compound (2) is inclusive of cis-trans structural isomers, and the cis-trans structural isomers are also within the scope of the present invention. Furthermore, in the above two reaction formulas, the structure of the pyridone compound (B) is different, but both are isomers in an equilibrium relationship and mean substantially the same compound.

The compound (2) according to the present invention can be produced by condensing an aldehyde compound (A) and a pyridone compound (B).

The aldehyde compound (A) used in the present invention can be synthesized with reference to a publicly known method disclosed in WO 92/19684. As preferable examples of the aldehyde compound (A), the aldehyde compounds (1) to (5) are shown below, but these compounds are not limiting.

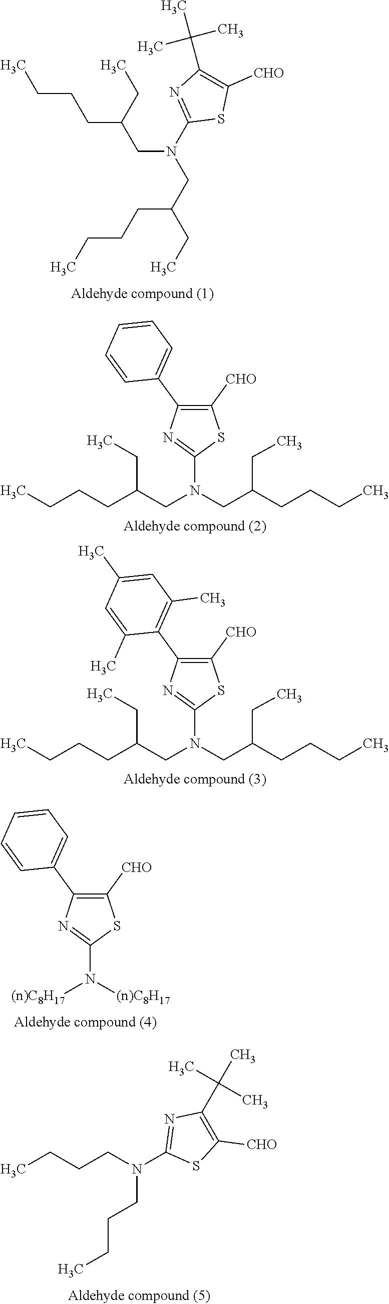

The cyclization step for obtaining the pyridone compound (B) will be described hereinbelow.

The pyridone compound (B) can be synthesized by a cyclization step of coupling three components, namely, a hydrazine compound, a methyl acetate compound, and an ethyl acetate compound.

This cyclization step can be carried out without a solvent, but it is preferably carried out in the presence of a solvent. The solvent is not particularly limited as long as it does not participate in the reaction, and examples thereof include water, methanol, ethanol, acetic acid, and toluene. Further, two or more kinds of solvents can be used in a mixture, and the mixing ratio at the time of mixing and use can be arbitrarily determined. The amount of the solvent to be used is preferably in the range of at least 0.1 part by mass and not more than 1000 parts by mass, and more preferably at least 1.0 part by mass and not more than 150 parts by mass with respect to 100 parts by mass of the methyl acetate compound.

In the cyclization step, it is preferable to use a base since the reaction can proceed rapidly when a base is used. Specific examples of the base that can be used include organic bases such as pyridine, piperidine, 2-methylpyridine, diethylamine, diisopropylamine, triethylamine, phenylethylamine, isopropylethylamine, methylaniline, 1,4-diazabicyclo[2.2.2]octane, tetrabutylammonium hydroxide, 1,8-diazabicyclo[5.4.0]undecene, potassium acetate, and the like; organometallics such as n-butyllithium, tert-butylmagnesium chloride, and the like; inorganic bases such as sodium borohydride, metallic sodium, potassium hydride, calcium oxide, and the like; and metal alkoxides such as potassium tert-butoxide, sodium tert-butoxide, sodium ethoxide, and the like. Among these, triethylamine and piperidine are preferable, and triethylamine is more preferable.

The amount of the base to be used is preferably in a range of at least 0.01 parts by mass and not more than 100 parts by mass, more preferably at least 0.1 parts by mass and not more than 20 parts by mass, and still more preferably at least 0.5 parts by mass and not more than 5 parts by mass with respect to 100 parts by mass of the methyl acetate compound. After completion of the reaction, a desired pyridone compound can be obtained by purification such as distillation, recrystallization, silica gel chromatography, and the like.

As preferable examples of the pyridone compound (B), the pyridone compounds (1) to (6) are shown below, but these compounds are not limiting.

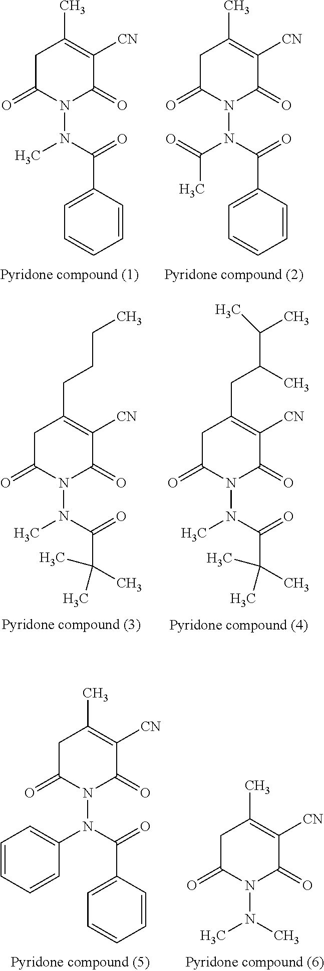 [SMILES: CC1=C(C#N)C(=O)N(N(C)C(=O)c2ccccc2)C(=O)C1 ; CC(=O)N(C(=O)c1ccccc1)N1C(=O)CC(C)=C(C#N)C1=O ; CCCCC1=C(C#N)C(=O)N(N(C)C(=O)C(C)(C)C)C(=O)C1 ; CC(C)C(C)CC1=C(C#N)C(=O)N(N(C)C(=O)C(C)(C)C)C(=O)C1 ; CC1=C(C#N)C(=O)N(N(C(=O)c2ccccc2)c2ccccc2)C(=O)C1 ; CC1=C(C#N)C(=O)N(N(C)C)C(=O)C1]

Next, the condensation step of obtaining the compound (2) will be described.

The compound (2) can be synthesized by a condensation step of condensing the aldehyde compound (A) and the pyridone compound (B). The condensation step can be carried out without a solvent, but it is preferably carried out in the presence of a solvent. The solvent is not particularly limited as long as it does not participate in the reaction, and examples thereof include chloroform, dichloromethane, N, N-dimethylformamide, toluene, xylene, tetrahydrofuran, dioxane, acetonitrile, ethyl acetate, methanol, ethanol, isopropanol, tetrahydrofuran, and the like. Further, two or more kinds of solvents can be used in a mixture, and the mixing ratio at the time of mixing and use can be arbitrarily determined.

The amount of the solvent to be used is preferably in the range of at least 0.1 parts by mass and not more than 1000 parts by mass, and more preferably at least 1.0 parts by mass and not more than 150 parts by mass with respect to 100 parts by mass of the aldehyde compound (A). The reaction temperature in the condensation step is preferably in a range of at least −80° C. and not more than 250° C., and more preferably at least −20° C. and not more than 150° C. The reaction in the condensation step is usually completed within 24 h.

Further, it is preferable that an acid or a base be used in the condensation step because the reaction can proceed rapidly. Specific examples of the acid which can be used include inorganic acids such as hydrochloric acid, sulfuric acid, phosphoric acid, and the like, organic acids such as p-toluenesulfonic acid, formic acid, acetic acid, propionic acid, trifluoroacetic acid, and the like, organic ammonium salts such as ammonium formate, ammonium acetate, and the like. Of these, p-toluenesulfonic acid, ammonium formate and ammonium acetate are preferable.

The amount of the acid to be used can be within a range of at least 0.01 parts by mass and not more than 20 parts by mass, and more preferably at least 0.1 parts by mass and not more than 5 parts by mass with respect to 100 parts by mass of the aldehyde compound (A).

In this condensation step, a base may be used. Specific examples of the base include organic bases such as pyridine, piperidine, 2-methylpyridine, diethylamine, diisopropylamine, triethylamine, phenylethylamine, isopropylethylamine, methylaniline, 1,4-diazabicyclo[2.2.2]octane, tetrabutylammonium hydroxide, 1,8-diazabicyclo[5.4.0]undecene, potassium acetate, and the like; organometallics such as n-butyllithium, tert-butylmagnesium chloride, and the like; inorganic bases such as sodium borohydride, metallic sodium, potassium hydride, calcium oxide, and the like; and metal alkoxides such as potassium tert-butoxide, sodium tert-butoxide, sodium ethoxide, and the like. Among these, triethylamine and piperidine are preferable, and triethylamine is more preferable.

The amount of the base to be used is preferably in a range of at least 0.1 parts by mass and not more than 20 parts by mass, and more preferably at least 0.2 parts by mass and not more than 5 parts by mass with respect to 100 parts by mass of the aldehyde compound (A).

The resulting compound (2) is treated according to a usual post-treatment method of an organic synthesis reaction and then purified by a fractionation operation, recrystallization, reprecipitation, column chromatography, and the like to obtain a high-purity compound.

The compound (2) that can be used in the present invention may be used singly or in combination of two or more thereof in order to adjust the color tone or the like according to the purpose of the intended use. Further, two or more known pigments and dyes can be used in combination. As preferable examples of the compound (2) that can be used in the present invention, the coloring compounds (1) to (6) are shown below, but these compounds are not limiting.

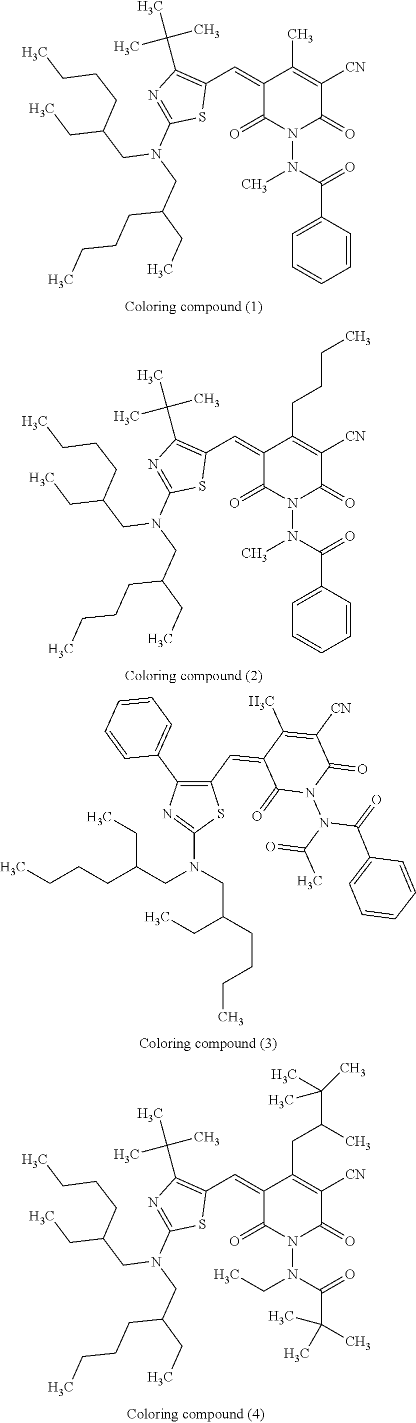 [SMILES: CCCCC(CC)CN(CC(CC)CCCC)c1nc(C(C)(C)C)c(/C=C2\C(=O)N(N(C)C(=O)c3ccccc3)C(=O)C(C#N)=C2C)s1 ; CCCCC1=C(C#N)C(=O)N(N(C)C(=O)c2ccccc2)C(=O)/C1=C\c1sc(N(CC(CC)CCCC)CC(CC)CCCC)nc1C(C)(C)C ; CCCCC(CC)CN(CC(CC)CCCC)c1nc(-c2ccccc2)c(/C=C2\C(=O)N(N(C(C)=O)C(=O)c3ccccc3)C(=O)C(C#N)=C2C)s1 ; CCCCC(CC)CN(CC(CC)CCCC)c1nc(C(C)(C)C)c(/C=C2\C(=O)N(N(CC)C(=O)C(C)(C)C)C(=O)C(C#N)=C2CC(C)C(C)(C)C)s1]

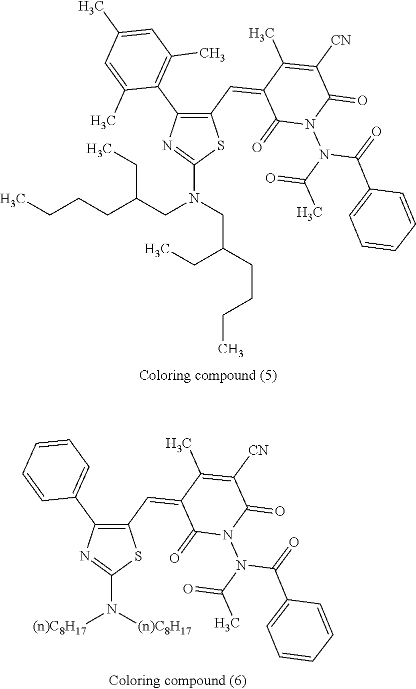

The compound (2) that can be used in the present invention may be used singly or in combination with two or more known pigments or dyes in order to adjust the color tone and the like according on the means for manufacturing the toner.

The binder resin is not particularly limited, and it is possible to include a known polymer or resin described below. Further, the following polymers or resins can be used singly or in combination of two or more thereof.

Homopolymers of styrene and substitution products thereof such as polystyrene, poly-p-chlorostyrene, polyvinyltoluene, and the like; styrene copolymers such as styrene-p-chlorostyrene copolymer, styrene-vinyltoluene copolymer, styrene-vinyl naphthalene copolymer, styrene-acrylic acid ester copolymer, styrene-methacrylic acid ester copolymer, styrene-α-chloromethacrylic acid methyl copolymer, styrene-acrylonitrile copolymer, styrene-vinyl methyl ether copolymer, styrene-vinyl ethyl ether copolymer, styrene-vinyl methyl ketone copolymer, styrene-acrylonitrile-indene copolymer, and the like; polyvinyl chloride, phenolic resins, natural resin-modified phenolic resins, natural resin-modified maleic acid resins, acrylic resins, methacrylic resins, polyvinyl acetate, silicone resins, polyester resins, polyurethanes, polyamide resins, furan resins, epoxy resins, xylene resins, polyvinyl butyral, terpene resins, coumarone-indene resins, and petroleum resins.

Among these, from the viewpoint of improving tinge stability, the binder resin preferably includes a polyester resin, particularly an amorphous polyester resin.

The content of the amorphous polyester resin in the binder resin is preferably at least 50% by mass and not more than 100% by mass, and more preferably at least 70% by mass and not more than 100% by mass.

The amorphous polyester resin has a “polyester structure” in the resin chain.

Specific examples of components constituting the amorphous polyester structure include a dihydric or higher alcohol component and a carboxylic acid component such as a divalent or higher carboxylic acid, a divalent or higher carboxylic acid anhydride, a divalent or higher carboxylic acid ester, and the like.

Examples of the dihydric or higher alcohol component are presented hereinbelow.

Alkylene oxide adducts of bispenol A such as polyoxypropylene (2.2)-2,2-bis(4-hydroxyphenyl)propane, polyoxypropylene (3.3)-2,2-bis (4-hydroxyphenyl)propane, polyoxyethylene (2.0)-2,2-bis (4-hydroxyphenyl)propane, polyoxypropylene (2.0)-polyoxyethylene (2.0)-2,2-bis(4-hydroxyphenyl)propane, polyoxypropylene (6)-2,2-bis(4-hydroxyphenyl)propane, and the like; ethylene glycol, diethylene glycol, triethylene glycol, 1,2-propanediol, 1,3-propanediol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbit, 1,2,3,6-hexanetetrol, 1,4-sorbitan, pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, trimethylolpropane, 1,3,5-trihydroxymethylbenzene, and the like.

Among them, aromatic diols are preferred.

In the amorphous polyester resin, the content ratio of the monomer unit derived from the aromatic diol is preferably at least 80 mol % and not more than 100 mol % with respect to all monomer units derived from the alcohol component constituting the amorphous polyester resin.

Also, the aromatic diol is preferably an alkylene oxide adduct of bisphenol A.

Meanwhile, examples of the carboxylic acid component such as a divalent or higher carboxylic acid, a divalent or higher carboxylic acid anhydride, a divalent or higher carboxylic acid ester, and the like are presented hereinbelow.

Aromatic dicarboxylic acids such as phthalic acid, isophthalic acid and terephthalic acid or anhydrides thereof; alkyl dicarboxylic acids such as succinic acid, adipic acid, sebacic acid and azelaic acid or anhydrides thereof; succinic acid substituted with an alkyl group or an alkenyl group having 6 to 18 carbon atoms or anhydrides thereof, unsaturated dicarboxylic acids such as fumaric acid, maleic acid and citraconic acid or anhydrides thereof.

The preferred examples among them include terephthalic acid, succinic acid, adipic acid, fumaric acid, trimellitic acid, pyromellitic acid, benzophenonetetracarboxylic acid or anhydrides thereof.

From the viewpoint of improving the dispersibility of the pigment and tinge stability, it is preferable that the acid value of the amorphous polyester resin be not more than 20 mg KOH/g, and more preferably not more than 15 mg KOH/g. When the acid value is in the above range, the dispersibility of the pigment is further improved and the tinge stability of the toner is further improved.

The acid value can be set within the above range by adjusting the type and amount of the monomer used for the amorphous polyester resin. Specifically, the acid value can be controlled by adjusting the compounding ratio of the alcohol monomer and acid monomer at the time of producing the resin, or the molecular weight of the resin. Further, the acid value can be adjusted by reacting a polyvalent carboxylic acid monomer (for example, trimellitic acid or anhydride thereof) with a hydroxy group present at the terminal of a polycondensate after condensation polymerization of the alcohol component and the carboxylic acid component.

It is preferable that the toner particle include a crystalline polyester resin.

In the present invention, the crystalline polyester resin is an additive to the toner particle and does not correspond to a binder resin.

The content of the crystalline polyester resin is preferably at least 5.0 parts by mass and not more than 30.0 parts by mass, more preferably at least 10.0 parts by mass and not more than 20.0 parts by mass with respect to 100.0 parts by mass of the binder resin.

When the content of the crystalline polyester resin is in the above range, the effect of the compound (1) on the crystal is sufficiently obtained, the crystalline polyester resin is easily finely dispersed in the toner particle, and the tinge stability of the toner is further improved.

The content ratio by mass of the crystalline polyester resin and the compound represented by Formula (1) (the crystalline polyester resin: the compound represented by Formula (1)) is preferably 75:25 to 30:70, and more preferably 65:35 to 40:60.

When the content ratio by mass is within the above range, a sufficient effect of the crystalline polyester resin on the crystal of the compound (1) is easily obtained, and the tinge stability of the toner is further improved.

The crystalline polyester resin can be obtained, for example, by reacting a divalent or higher polyvalent carboxylic acid and a diol.

Among them, a polycondensate of an aliphatic diol and an aliphatic dicarboxylic acid is preferred because of a high degree of crystallinity and easy interaction with the compound (1).

Further, only one type of crystalline polyester resin may be used, or a plurality of types of crystalline polyester resins may be used in combination.

The crystalline polyester resin is preferably a polycondensate of an alcohol component including at least one compound selected from the group consisting of aliphatic diols having at least 2 and not more than 22 carbon atoms and derivatives thereof, and a carboxylic acid component including at least one compound selected from the group consisting of aliphatic dicarboxylic acids having at least 2 and not more than 22 carbon atoms and derivatives thereof.

Among them, from the viewpoint of improving tinge stability, a polycondensate of an alcohol component including at least one compound selected from the group consisting of aliphatic diols having at least 6 and not more than 12 carbon atoms and derivatives thereof, and a carboxylic acid component including at least one compound selected from the group consisting of aliphatic dicarboxylic acids having at least 6 and not more than 12 carbon atoms and derivatives thereof is preferred.

Since the crystallinity of the crystalline polyester resin produces a stronger effect as the molecular weight of the aliphatic dicarboxylic acid of the crystalline polyester resin increases, a strong interaction with the compound (1) is demonstrated. Therefore, it is easy to control the crystallinity of the compound (1).

The aliphatic diol having at least 2 and not more than 22 carbon atoms (preferably at least 6 and not more than 12 carbon atoms) is not particularly limited, but from the viewpoint of improving tinge stability of the toner, a chain (preferably linear) aliphatic diol is preferred.

Examples of such diols include ethylene glycol, diethylene glycol, triethylene glycol, 1,2-propylene glycol, dipropylene glycol, 1,3-propanediol, 1,4-butanediol, 1,4-butadiene glycol, 1,5-pentanediol, neopentyl glycol, 1,6-hexanediol, 1,7-heptanediol, 1,8-octanediol, 1,9-nonanediol, 1,10-decanediol, 1,11-undecanediol, and 1,12-dodecanediol.

The preferred examples among them include linear aliphatic α, ω-diols such as 1,6-hexanediol, 1,7-heptanediol, 1,8-octanediol, 1,9-nonanediol, 1,10-decanediol, 1,11-undecanediol, 1,12-dodecanediol, and the like.

The abovementioned derivatives are not particularly limited as long as a similar resin structure can be obtained by polycondensation. Examples of such derivatives are obtained by esterifying a diol.

In the alcohol component constituting the crystalline polyester resin, the content ratio of the at least one compound selected from the group consisting of aliphatic diols having at least 2 and not more than 22 carbon atoms (preferably at least 6 and not more than 12 carbon atoms) and derivatives thereof to the entire alcohol component constituting the crystalline polyester resin is preferably at least 50% by mass, and more preferably at least 70% by mass.

A polyhydric alcohol other than the aliphatic diol may also be used.

Among the polyhydric alcohols, examples of diols other than the aliphatic diols include aromatic alcohols such as polyoxyethylenated bisphenol A and polyoxypropylenated bisphenol A; 1,4-cyclohexanedimethanol, and the like.

Examples of the trihydric or higher polyhydric alcohols among the polyhydric alcohols include aromatic alcohols such as 1,3,5-trihydroxymethylbenzene and the like; and aliphatic alcohols such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, trimethylolpropane, and the like.

Furthermore, a monohydric alcohol may also be used to such an extent that the properties of the crystalline polyester resin are not impaired. Examples of the monohydric alcohol include n-butanol, isobutanol, sec-butanol, n-hexanol, n-octanol, 2-ethylhexanol, cyclohexanol, benzyl alcohol, and the like.

Meanwhile, the aliphatic dicarboxylic acid having at least 2 and not more than 22 carbon atoms (preferably at least 6 and not more than 12 carbon atoms) is not particularly limited, and may be a chain (preferably, a linear) aliphatic dicarboxylic acid.

Examples of such acids include oxalic acid, malonic acid, succinic acid, glutaric acid, adipic acid, pimelic acid, suberic acid, glutaconic acid, azelaic acid, sebacic acid, nonanedicarboxylic acid, decanedicarboxylic acid, undecanedicarboxylic acid, dodecanedicarboxylic acid, maleic acid, fumaric acid, mesaconic acid, citraconic acid, and itaconic acid.

Hydrolyzates of lower alkyl esters or anhydrides of these acids can also be included.

In addition, the abovementioned derivatives are not particularly limited as long as a similar resin structure can be obtained by polycondensation. Examples thereof include anhydrides of the dicarboxylic acid component and derivatives obtained by methyl esterification, ethyl esterification, or acid chloride conversion of the dicarboxylic acid components.

In the carboxylic acid component constituting the crystalline polyester resin, the content ratio of the at least one compound selected from the group consisting of aliphatic dicarboxylic acids having at least 2 and not more than 22 carbon atoms (preferably at least 6 and not more than 12 carbon atoms) and derivatives thereof to the entire dicarboxylic acid component constituting the crystalline polyester resin is preferably at least 50% by mass, and more preferably at least 70% by mass.

A polyvalent carboxylic acid other than the abovementioned aliphatic dicarboxylic acids can also be used. Among the polyvalent carboxylic acids, examples of divalent carboxylic acids other than the abovementioned aliphatic dicarboxylic acids include aromatic carboxylic acids such as isophthalic acid, terephthalic acid, and the like; aliphatic carboxylic acids such as n-dodecylsuccinic acid, n-dodecenylsuccinic acid, and the like; and alicyclic carboxylic acids such as cyclohexanedicarboxylic acid and the like, and also include acid anhydrides or lower alkyl esters thereof.

Among the other polyvalent carboxylic acids, examples of trivalent or higher polycarboxylic acids include aromatic carboxylic acids such as 1,2,4-benzenetricarboxylic acid (trimellitic acid), 2,5,7-naphthalenetricarboxylic acid, 1,2,4-naphthalenetricarboxylic acid, pyromellitic acid, and the like; and aliphatic carboxylic acid such as 1,2,4-butanetricarboxylic acid, 1,2,5-hexanetricarboxylic acid, 1,3-dicarboxyl-2-methyl-2-methylenecarboxypropane, and the like. Derivatives such as acid anhydrides and lower alkyl esters thereof can also be included.

Furthermore, a monovalent carboxylic acid may also be used to such an extent that the properties of the crystalline polyester resin are not impaired. Examples of the monovalent carboxylic acids include benzoic acid, naphthalenecarboxylic acid, salicylic acid, 4-methylbenzoic acid, 3-methylbenzoic acid, phenoxyacetic acid, biphenylcarboxylic acid, acetic acid, propionic acid, butyric acid, octanoic acid, and the like.

The crystalline polyester resin can be produced according to a usual polyester synthesis method. For example, a crystalline polyester resin can be obtained by subjecting the carboxylic acid component and the alcohol component to an esterification reaction or a transesterification reaction, followed by condensation polymerization reaction under reduced pressure or introduction of nitrogen gas according to a conventional method.

The esterification or transesterification reaction can be carried out using, as necessary, an ordinary esterification catalyst or a transesterification catalyst such as sulfuric acid, titanium butoxide, tin 2-ethylhexanoate, dibutyltin oxide, manganese acetate, magnesium acetate, and the like.

The polycondensation reaction can be carried out by using a publicly known catalyst such as a usual polymerization catalyst, for example, titanium butoxide, tin 2-ethylhexanoate, dibutyltin oxide, tin acetate, zinc acetate, tin disulfide, antimony trioxide, germanium dioxide, and the like. The polymerization temperature and the catalyst amount are not particularly limited, and may be appropriately determined.

In the esterification or transesterification reaction or polycondensation reaction, all the monomers may be charged at once in order to increase the strength of the obtained crystalline polyester resin, or divalent monomers may be initially reacted followed by the addition and reaction of trivalent and higher monomers in order to reduce the amount of the low molecular weight component.

The toner particles may include wax as required.

Specific examples thereof include hydrocarbon waxes such as low molecular weight polyethylene, low molecular weight polypropylene, alkylene copolymers, microcrystalline wax, paraffin wax and Fischer Tropsch wax; oxides of hydrocarbon waxes such as oxidized polyethylene wax or block copolymers thereof; waxes mainly composed of fatty acid esters such as carnauba wax; and waxes obtained by partially or wholly deoxidizing fatty acid esters, such as deoxidized carnauba wax.

Further, the following compounds can also be mentioned. Saturated linear fatty acids such as palmitic acid, stearic acid, and montanic acid; unsaturated fatty acids such as brassidic acid, eleostearic acid, and parinaric acid; saturated alcohols such as stearyl alcohol, aralkyl alcohol, behenyl alcohol, carnaubyl alcohol, seryl alcohol, and melissyl alcohol; polyhydric alcohols such as sorbitol and the like; esters of fatty acids such as palmitic acid, stearic acid, behenic acid, and montanic acid with alcohols such as stearyl alcohol, aralkyl alcohol, behenyl alcohol, carnaubyl alcohol, seryl alcohol, and melissyl alcohol; fatty acid amides such as linoleic acid amide, oleic acid amide, and lauric acid amide; saturated fatty acid bisamides such as methylene bis-stearic acid amide, ethylene bis-capric acid amide, ethylene bis-lauric acid amide, and hexamethylene bis-stearic acid amide; unsaturated fatty acid amides such as ethylene bis-oleic acid amide, hexamethylene bis-oleic acid amide, N,N′-dioleyladipic acid amide, and N,N′-dioleylsebacic acid amide; aromatic bisamides such as m-xylene bis-stearic acid amide and N,N′-distearylisophthalic acid amide; aliphatic metal salts such as calcium stearate, calcium laurate, zinc stearate, and magnesium stearate (commonly referred to as metallic soaps); waxes obtained by grafting aliphatic hydrocarbon wax using a vinyl monomer such as styrene and acrylic acid; partial esterification products of fatty acids and polyhydric alcohols, such as monoglyceride behenate; and methyl ester compounds having a hydroxyl group and obtained by hydrogenation of vegetable fats and oils.

Among these waxes, Fischer-Tropsch wax is preferable from the viewpoint of improving tinge stability.

The content of the wax is preferably at least 0.5 parts by mass and not more than 20.0 parts by mass and more preferably at least 3.0 parts by mass and not more than 12.0 parts by mass with respect to 100 parts by mass of the binder resin.

Further, from the viewpoint of improving the tinge stability of the toner, it is preferable that in the endothermic curve of the wax at the time of temperature increase measured by a differential scanning calorimeter (DSC), the peak temperature of the maximum endothermic peak present in the temperature range of at least 30° C. and not more than 200° C. be at least 50° C. and not more than 110° C. It is more preferable that the peak temperature of the maximum endothermic peak be at least 70° C. and not more than 100° C.

It is preferable that the toner particle include a polymer in which a styrene acrylic resin having a structural moiety derived from a saturated alicyclic compound be graft polymerized to a polyolefin (hereinafter also simply referred to as “polymer”).

Further, in the present invention, the polymer is an additive to the toner particle and does not correspond to the binder resin.

The effect obtained when the toner particle includes the polymer is that the polymer interacts with the compound (1) in the toner particle, thereby weakening the crystallinity of the compound (1) and improving the tinge stability.

The content of the polymer is preferably at least 3.0 parts by mass and not more than 15.0 parts by mass and more preferably at least 5.0 parts by mass and not more than 10.0 parts by mass with respect to 100.0 parts by mass of the binder resin.

It is preferable that the peak temperature of the maximum endothermic peak of the polyolefin measured with a differential scanning calorimeter (DSC) be at least 60° C. and not more than 110° C.

The softening temperature of the polyolefin is preferably at least 70° C. and not more than 100° C.

It is preferable that the polyolefin have a weight average molecular weight (Mw) of at least 900 and not more than 50000.

The content of the polyolefin in the polymer is preferably at least 5.0% by mass and not more than 20.0% by mass, and more preferably at least 8.0% by mass and not more than 12.0% by mass.

A method of graft polymerizing the styrene acrylic resin to the polyolefin is not particularly limited, and a conventionally known method can be used.

The styrene acrylic resin has a structural site derived from a saturated alicyclic compound.

For example, in one embodiment, the styrene acrylic resin has a monomer unit represented by Formula (a) below.

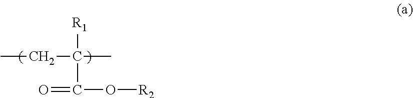

(In Formula (a), R₁ represents a hydrogen atom or a methyl group, and R₂ represents a saturated alicyclic group.)

The saturated alicyclic group in R₂ is preferably a saturated alicyclic hydrocarbon group, more preferably a saturated alicyclic hydrocarbon group having at least 3 and not more than 18 carbon atoms, and still more preferably a saturated alicyclic hydrocarbon group having at least 4 and not more than 12 carbon atoms.

The saturated alicyclic group is preferably a cycloalkyl group having at least 4 and not more than 12 carbon atoms, and more preferably a cycloalkyl group having at least 6 and not more than 10 carbon atoms.

Specific examples of the saturated alicyclic group include a cyclopropyl group, a cyclobutyl group, a cyclopentyl group, a cyclohexyl group, a cycloheptyl group, a cyclooctyl group, and the like.

The content ratio of the monomer unit represented by Formula (a) is preferably at least 1.5 mol % and not more than 45.0 mol %, and more preferably at least 3.0 mol % and not more than 25.0 mol %, based on all the monomer units constituting the styrene acrylic resin.

Specific examples of the styrene acrylic resin include a resin having a monomer unit represented by Formula (a) and a monomer unit derived from the following monomers.

Styrene monomers such as styrene, α-methylstyrene, p-methylstyrene, m-methylstyrene, p-methoxystyrene, p-hydroxystyrene, p-acetoxystyrene, vinyltoluene, ethylstyrene, phenylstyrene, benzylstyrene, and the like; and

alkyl esters of unsaturated carboxylic acids (the number of carbon atoms in the alkyl is at least 1 and not more than 18) such as methyl acrylate, ethyl acrylate, butyl acrylate, 2-ethylhexyl acrylate, methyl methacrylate, ethyl methacrylate, butyl methacrylate, 2-ethylhexyl methacrylate, and the like.

The colorant includes a compound represented by Formula (1) below, which is a quinacridone pigment.

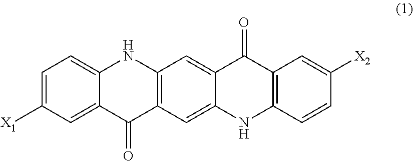

(In Formula (1), X₁ and X₂ each independently represent a hydrogen atom, a chlorine atom or a methyl group.)

From the viewpoint of improving the dispersibility of the pigment in the toner particle and tinge stability, it is preferable that X₁ and X₂ be each independently a hydrogen atom or a methyl group.

The compounds represented by Formula (1) can be used singly or in combination of a plurality thereof.

Further, this compound may be a solid solution of two or more quinacridone compounds.

In addition, the compound may be treated with a rosin compound including abietic acid or the like in order to facilitate dispersion in the binder resin.

The colorant may include a pigment or a dye other than the compound represented by Formula (1) to the extent that the properties of the present invention are not impaired.

Examples of magenta pigments that can be used in addition to the compound (1) are presented hereinbelow.

C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, 282; C. I. Pigment Violet 19; C. I. Vat Red 1, 2, 10, 13, 15, 23, 29, 35. These pigments may be used singly or in combination of a plurality thereof.

Examples of magenta dyes that can be used in addition to the compound (1) are presented hereinbelow.

Oil soluble dye such as C. I. Solvent Red 1, 3, 8, 23, 24, 25, 27, 30, 49, 81, 82, 83, 84, 100, 109, 121; C. I. Disperse Red 9; C. I. Solvent Violet 8, 13, 14, 21, 27; and C. I. Disperse Violet 1, and basic dyes such as C. I. Basic Red 1, 2, 9, 12, 13, 14, 15, 17, 18, 22, 23, 24, 27, 29, 32, 34, 35, 36, 37, 38, 39, 40; and C. I. Basic Violet 1, 3, 7, 10, 14, 15, 21, 25, 26, 27, 28. These dyes may be used singly or in combination of a plurality thereof.

The content of the colorant is preferably at least 0.1 part by mass and not more than 20.0 parts by mass with respect to 100 parts by mass of the binder resin.

The toner particles may also include, as necessary, a charge control agent.

As the charge control agent, a known charge control agent can be used, in particular, preferably a metal compound of an aromatic carboxylic acid which is colorless, ensures a high charging speed of the toner, and can stably maintain a constant charge quantity.

Examples of the negative charge control agent include salicylic acid metal compounds, naphthoic acid metal compounds, dicarboxylic acid metal compounds, polymer type compounds having a sulfonic acid or a carboxylic acid in a side chain, polymer type compounds having a sulfonic acid salt or a sulfonic acid esterification product in a side chain, polymer type compounds having a carboxylic acid salt or a carboxylic acid esterification product in a side chain, boron compounds, urea compounds, silicon compounds, calixarenes, and the like.

The charge control agent may be added to the toner particle internally or externally.

The content of the charge control agent is preferably at least 0.2 parts by mass and not more than 10.0 parts by mass with respect to 100 parts by mass of the binder resin.

The toner may include, as necessary, an external additive for improving flowability and adjusting the triboelectric charge quantity.

As the external additive, inorganic fine particles such as silica fine particles, titanium oxide fine particles, aluminum oxide fine particles and strontium titanate fine particles are preferable. The inorganic fine particles are preferably hydrophobized with a hydrophobizing agent such as a silane compound, silicone oil or a mixture thereof.

From the viewpoint of suppression of embedment of external additive, it is preferable that the specific surface area of the external additive be at least 10 m²/g and not more than 50 m²/g.

The content of the external additive is preferably at least 0.1 parts by mass and not more than 5.0 parts by mass with respect to 100 parts by mass of the toner particles.

Mixing of the toner particle and the external additive is not particularly limited, and a known mixer such as a HENSCHEL MIXER can be used.

From the viewpoint of obtaining a stable image over a long period of time, it is preferable to use the toner as a two-component developer mixed with a magnetic carrier.

Examples of the magnetic carrier include generally well-known materials such as metal particles such as iron, lithium, calcium, magnesium, nickel, copper, zinc, cobalt, manganese, and rare earths, alloy particles thereof or oxide particles thereof; magnetic materials such as ferrites and the like; magnetic body-dispersed resin carriers (so-called resin carrier) including magnetic bodies and a binder resin which holds the magnetic bodies in a dispersed state, and the like.

The toner production method is not particularly limited, but from the viewpoint of controlling the crystallinity of the compound (1) in the toner particle and improving the dispersibility, it is preferable to use a melt-kneading method.

That is, the method for producing the toner of the present invention is as follows.

A method for producing a toner having a toner particle, the method including:

a melt-kneading step of melt-kneading, with a twin-screw extruder, a mixture including a binder resin including an amorphous polyester resin, a colorant including a compound represented by Formula (1), and a crystalline polyester resin, wherein

when a barrel setting temperature of a kneading portion of a melt-kneading shaft of the twin-screw extruder in the melt-kneading step is denoted by Ta (° C.) and a softening temperature of the binder resin is denoted by Tm (° C.), the Ta and the Tm satisfy Formula (4) below.

−10≤Tm−Ta≤30 (4)

Where the toner is produced through the melt-kneading step, the crystallinity of the compound (1) changes under the effect of heat and shear. As a result, the compound (1) is finely dispersed in the toner particle, and the tinge stability is improved.

Hereinafter, the procedure for producing the toner by using the melt-kneading method will be described.

In a raw material mixing step, predetermined amounts of a binder resin, colorant and optionally other components such as a wax and a charge control agent are weighed and blended, and then mixed as materials constituting the toner particle.

Examples of the mixing device include a double cone mixer, a V-type mixer, a drum mixer, a super mixer, a HENSCHEL MIXER, a NAUTA MIXER, a MECHANO HYBRID (manufactured by Nippon Coke & Engineering Co., Ltd.), and the like.

Next, the mixed material is melt-kneaded to disperse components such as the colorant and the like in the binder resin.

In the melt-kneading step, it is possible to use a batch type kneader such as a pressure kneader, a Banbury mixer, and the like, or a continuous type kneader, and single- and twin-screw extruders are mainly used due to their superiority in terms of enabling continuous production.

Examples of such devices include a KTK-type twin-screw extruder (manufactured by Kobe Steel Ltd.), a TEM-type twin-screw extruder (manufactured by Toshiba Machine Co., Ltd.), a PCM kneader (manufactured by Ikegai Iron Works Co., Ltd.), a twin screw extruder (manufactured by K.C.K. Co., Ltd.), a co-kneader (manufactured by Buss Co.), Kneadex (manufactured by Nippon Coke & Engineering Co., Ltd.), and the like.

Further, the kneaded material obtained by melt-kneading may be rolled with a two-roll or the like and cooled by water or the like in the cooling step.

A twin-screw extruder may be used as the kneader.

The twin-screw extruder is a kneader in which two melt-kneading shafts called paddles pass through a barrel serving as a heating cylinder for keeping the temperature constant.

An example of the twin-screw extruder is shown in the FIGURE. A raw material mixture is supplied from one end of the melt-kneading shafts and kneaded by rotation of the melt-kneading shafts, while being heated and melted, to be extruded from the other end.

A vent hole mainly for degassing may be arranged in the intermediate section of the kneader. A propeller-like cross section or a triangular cross section is used for the melt-kneading shafts, and the melt-kneading shafts are set with a phase shift to rotate so that the distal end of one shaft always rubs against the other shaft. With this structure, a self-cleaning action is maintained such that the kneaded material is fed forward without adhering to the melt-kneading shafts or the barrel wall.

In the present invention, it is preferable that the rotational directions of the two melt-kneading shafts be the same.

An appropriate shearing force can be applied as a result of rotating the melt-kneading shaft in the same direction, whereby the compound (1) can be dispersed uniformly and the crystal growth of the compound (1) can be suppressed.

The melting portion is a portion of the melt-kneading shaft from a barrel (C1) next to the material supply port to the extrusion port. Usually, the barrel (C0) of the material supply port causes no melting because it is necessary to let the material penetrate into the melt-kneading shafts. Therefore, this barrel is not a melting portion.

It is preferable that the length of the melting portion of the melt-kneading shaft be at least 500 mm and not more than 1500 mm.

When the length of the melting portion is within the above range, the melt residence time of the mixture becomes appropriate, so that sufficient kneading can be performed. In addition, since excessive heat and shear are prevented from being applied to the kneaded material, the crystal structure of the compound (1) can be appropriately controlled and high tinge stability can be obtained.

The melt-kneading shaft is generally composed of two kinds of portions, one being a feed screw portion and the other being a kneading portion. The screw portion has a function of feeding the melt-kneaded material forward while heating. When the viscosity of the melt-kneaded material in the cylinder is high, the material is kneaded by a shear force created by friction between the wall of the screw portion and the melt-kneaded material. Meanwhile, when the viscosity is low, the material is difficult to knead. Further, practically no effect of feeding the melt-kneaded material forward is demonstrated in the kneading portion, and the kneaded material stagnates and fills up the kneading portion.

Where the barrel setting temperature of the kneading portion of the melt-kneading shaft of the twin-screw extruder in the melt-kneading step of the toner manufacturing method is denoted by Ta (° C.) and the softening temperature of the binder resin of the toner is denoted by Tm (° C.), the Ta and the Tm satisfy Formula (4) below. It is also preferable that the Ta and the Tm satisfy Formula (4)′ below.

−10≤Tm−Ta≤30 (4)

10≤Tm−Ta≤25(4)′

When [Tm−Ta] (° C.) exceeds 30, since the shear applied to the crystals of the compound (1) is too strong, the crystal structure collapses and the chromogenecity of the toner deteriorates. Meanwhile, when [Tm−Ta] (° C.) is less than −10° C., the effect of compression and stretching accompanying the rotation of the melt-kneading shafts performed in the kneading portion is small. Therefore, since the shear applied to the crystals of the compound (1) is weakened, tinge stability is lowered.

That is, by controlling the [Tm−Ta] (° C.) within the above range, it is possible to effectively obtain the shear during melt-kneading in the kneading portion.

Subsequently, the cooled product of the kneaded material may be pulverized to a desired particle size in the pulverizing step. In the pulverizing step, for example, after coarse pulverizing with a crushing machine such as a crusher, a hammer mill, a feather mill or the like, fine pulverizing may be further carried out with a KRYPTRON SYSTEM (manufactured by Kawasaki Heavy Industries, Ltd.), SUPER ROTOR (manufactured by Nisshin Engineering Inc.), a turbo mill (manufactured by Turbo Kogyo Co., Ltd.), or a fine pulverization machine of an air jet system.

Then, toner particles may be obtained by classifying, as necessary, by using a classifier or a sieve such as an ELBOW JET of an inertia classification system (manufactured by Nittetsu Mining Co., Ltd.), a TURBOPLEX of a centrifugal force classification system (manufactured by Hosokawa Micron Corporation), a TSP separator (manufactured by Hosokawa Micron Corporation), and FACULTY (manufactured by Hosokawa Micron Corporation).

Thereafter, a toner can be obtained by mixing (externally adding) external additives such as inorganic fine particles and resin particles selected as necessary, thereby improving, for example, flowability.

A device having a rotating body having an stirring member and a main body casing provided so that there is a gap between the stirring member and the main body casing may be used as the mixing device.

Examples of the mixing device include a HENSCHEL MIXER (manufactured by Mitsui Mining Co., Ltd.); Super Mixer (manufactured by Kawata Corporation); Ribocone (manufactured by Okawara Mfg. Co., Ltd.); NAUTA MIXER, TURBULIZER, CYCLOMIX (manufactured by Hosokawa Micron Corporation); Spiral Pin Mixer (manufactured by Pacific Machinery & Engineering Co., Ltd.); Loedige mixer (manufactured by Matsubo Corporation), NOBILTA (manufactured by Hosokawa Micron Corporation), and the like. A HENSCHEL MIXER (manufactured by Mitsui Mining Co., Ltd.) may be used to uniformly mix the toner particles and the external additive and loosen the external additive.

The treatment amount of the external additive, the rotation speed of the stirring shaft, the stirring time, the shape of the stirring blade, the temperature in the device, and the like can be appropriately selected as the mixing conditions to achieve the desired toner performance.

In addition, for example, when a coarse aggregate of the additive is present in the obtained toner in a free state, a sieve or the like may be used as necessary.

Hereinafter, methods for measuring various physical properties of the toner and the raw material will be described.

### <Method for Measuring Peak Molecular Weight (Mp), Number Average Molecular Weight (Mn), and Weight Average Molecular Weight (Mw) of Resin>

The peak molecular weight (Mp), number average molecular weight (Mn), and weight average molecular weight (Mw) of the resin are measured in the following manner by using gel permeation chromatography (GPC).

First, the sample (resin) is dissolved in tetrahydrofuran (THF) at room temperature over 24 h. Then, the obtained solution is filtered through a solvent-resistant membrane filter “Sample Pretreatment Cartridge” (manufactured by Tosoh Corporation) having a pore diameter of 0.2 μm to obtain a sample solution. The sample solution is adjusted so that the concentration of the component soluble in THF is about 0.8% by mass. Measurements are performed under the following conditions by using this sample solution.

Apparatus: HLC 8120 GPC (detector: RI) (manufactured by Tosoh Corporation)
Column: Seven sets of Shodex KF-801, 802, 803, 804, 805, 806, 807 (manufactured by Showa Denko K.K.)
Eluent: tetrahydrofuran (THF)
Flow rate: 1.0 mL/min
Oven temperature: 40.0° C.
Sample injection amount: 0.10 mL

When the molecular weight of the sample is calculated, a molecular weight calibration curve is used which is prepared using a standard polystyrene resin (trade name “TSK Standard Polystyrene F-850, F-450, F-288, F-128, F-80, F-40, F-20, F-10, F-4, F-2, F-1, A-5000, A-2500, A-1000, A-500”, manufactured by Tosoh Corporation).

<Method for Measuring Softening Temperature of Resin>

Measurement of the softening temperature (Tm) of the resin is performed using a capillary rheometer “Flow Tester CFT-500D” of a constant-load extrusion system (manufactured by Shimadzu Corporation) according to the manual supplied with the device. In this device, the temperature of the measurement sample filled in a cylinder is raised to melt the sample while applying a constant load with a piston from the upper part of the measurement sample, the melted measurement sample is extruded from the die at the bottom of the cylinder, and a flow curve representing the relationship between the piston descent amount and the temperature at this time can be obtained.

In the present invention, the “melting temperature in ½ method” described in the manual supplied with a “Flow Characteristic Evaluation Apparatus: Flow Tester CFT-500D” is taken as the softening temperature.

The melting temperature in the ½ method is calculated in the following manner.

First, ½ of the difference between the descent amount Smax of the piston at the time when the outflow has ended and the descent amount Smin of the piston at the time when the outflow has started is calculated (this is taken as X; X=(Smax−Smin)/2). The temperature at the flow curve when the descent amount of the piston at the flow curve becomes the sum of X and Smin is the melting temperature in the ½ method.

About 1.0 g of the resin is compression molded for about 60 sec at about 10 MPa by using a tablet molding compressor (NT-100H, manufactured by NPa System Co., Ltd.) in an environment of 25° C. to obtain a columnar shape with a diameter of about 8 mm.

Measurement conditions of CFT-500D are presented hereinbelow.

Test mode: temperature rise method
Onset temperature: 40° C.
Saturated temperature: 200° C.
Measurement interval: 1.0° C.
Ramp rate: 4.0° C./min
Piston cross section area: 1.000 cm²
Test load (piston load): 10.0 kgf (0.9807 MPa)
Preheating time: 300 sec
Die hole diameter: 1.0 mm
Die length: 1.0 mm

<Method for Measuring Acid Value of Resin>

The acid value is the number of milligrams of potassium hydroxide necessary for neutralizing the acid contained in 1 g of the sample. The acid value of the binder resin is measured according to JIS K 0070-1992, more specifically, according to the following procedure.

### (1) Preparation of Reagents

A total of 1.0 g of phenolphthalein is dissolved in 90 mL of ethyl alcohol (95% by volume), and ion-exchanged water is added to make 100 mL and obtain a phenolphthalein solution.

A total of 7 g of special grade potassium hydroxide is dissolved in 5 mL of water and ethyl alcohol (95% by volume) is added to make 1 L. The solution is placed in an alkali-resistant container to prevent contact with carbon dioxide gas, allowed to stand for 3 days, and then filtered to obtain a potassium hydroxide solution. The obtained potassium hydroxide solution is stored in an alkali-resistant container.

A total of 25 mL of 0.1 mol/L hydrochloric acid is taken into an Erlenmeyer flask, a few drops of phenolphthalein solution are added, and titration is performed with the potassium hydroxide solution. A factor of the potassium hydroxide solution is determined from the amount of the potassium hydroxide solution required for neutralization. The 0.1 mol/L hydrochloric acid is prepared according to JIS K 8001-1998.

### (2) Operation

### (A) Main Test

A total of 2.0 g of the sample is accurately weighed in a 200 mL Erlenmeyer flask, 100 mL of a mixed solution of toluene/ethanol (2:1) is added and dissolved over 5 h. Then a few drops of phenolphthalein solution are added as an indicator and titration is performed using the potassium hydroxide solution. The end point of the titration is when the light crimson color of the indicator lasts about 30 sec.

### (B) Blank Test

Titration is performed in the same manner as in the above-described operation except that no sample is used (that is, only a mixed solution of toluene/ethanol (2:1) is used).

(3) The Obtained Value is Substituted into the Following Equation to Calculate the Acid Value.

A=[(C−B)×f×5.61]/S

Here, A is the acid value (mg KOH/g), B is the addition amount (mL) of the potassium hydroxide solution in the blank test, C is the addition amount (mL) of the potassium hydroxide solution in the main test, f is the factor of the potassium hydroxide solution, S is the sample (g).

<Method for Measuring Hydroxyl Value of Resin>

The hydroxyl value is the number of milligrams of potassium hydroxide required to neutralize acetic acid bonded to the hydroxyl group when 1 g of sample is acetylated. The hydroxyl value of the binder resin is measured according to HS K 0070-1992, specifically, according to the following procedure.

### (1) Preparation of Reagents

A total of 25 g of special grade anhydrous acetic acid is placed in a 100 mL measuring flask, pyridine is added to make the total amount 100 mL, and sufficient shaking is performed to obtain an acetylation reagent. The obtained acetylation reagent is stored in a brown bottle so as to prevent contact with moisture, carbon dioxide, and the like.

A total of 1.0 g of phenolphthalein is dissolved in 90 mL of ethyl alcohol (95% by volume), and ion-exchanged water is added to make 100 mL and obtain a phenolphthalein solution.

A total of 35 g of special grade potassium hydroxide is dissolved in 20 mL of water, and ethyl alcohol (95% by volume) is added to make 1 L. The solution is placed in an alkali-resistant container to prevent contact with carbon dioxide and the like, allowed to stand for 3 days and then filtered to obtain a potassium hydroxide solution. The obtained potassium hydroxide solution is stored in an alkali-resistant container. A total of 25 mL of 0.5 mol/L hydrochloric acid is taken into an Erlenmeyer flask, a few drops of phenolphthalein solution are added, and titration is performed with the potassium hydroxide solution. A factor of the potassium hydroxide solution is determined from the amount of the potassium hydroxide solution required for neutralization. The 0.5 mol/L hydrochloric acid is prepared according to JIS K 8001-1998.

### (2) Operation

### (A) Main Test

A total of 1.0 g of the pulverized resin sample is accurately weighed in a 200 mL round-bottom flask, and 5.0 mL of the acetylation reagent is precisely added using a hole pipette. In this case, when the sample is difficult to dissolve in the acetylation reagent, a small amount of special grade toluene is added to enhance dissolution.

A small funnel is placed in the mouth of the flask, and about 1 cm of the bottom of the flask is immersed and heated in a glycerin bath at about 97° C. At this time, in order to prevent the temperature of the neck of the flask from rising due to the heat of the bath, it is preferable to place a cardboard with a round hole on the base of the neck of the flask.

After 1 h, the flask is removed from the glycerin bath and allowed to cool. After cooling down, 1 mL of water is added from a funnel and the flask is shaken to hydrolyze acetic anhydride. For even more complete hydrolysis, the flask is again heated in a glycerin bath for 10 min. After the flask is allowed to cool, the funnel and flask walls are washed with 5 mL of ethyl alcohol.

A few drops of phenolphthalein solution are added as an indicator and titration is performed with the potassium hydroxide solution. The end point of the titration is when the light crimson color of the indicator lasts about 30 sec.

### (B) Blank Test

Titration is performed in the same manner as in the above-described operation except that no sample is used.

(3) The Obtained Value is Substituted into the Following Equation to Calculate the Hydroxyl Value.

A=[{(B−C)×28.05×f}/S]+D

Here, A is hydroxyl value (mg KOH/g), B is the addition amount (mL) of the potassium hydroxide solution in the blank test, C is the addition amount (mL) of the potassium hydroxide solution in the main test, f is the factor of the potassium hydroxide solution, S is the sample (g), D is the acid value (mg KOH/g) of the resin.

[Method for Measuring Weight Average Particle Diameter (D4) of Toner Particles]

The weight average particle diameter (D4) of the toner particles is calculated by using a precision particle size distribution measuring device “Coulter Counter Multisizer 3” (registered trade name, produced by Beckman Coulter Inc.) based on a pore electrical resistance method and including a 100 μm aperture tube, and the dedicated software “Beckman Coulter Multisizer 3 Version 3.51” (produced by Beckman Coulter Inc.) supplied with the device for setting measurement conditions and performing analysis of measurement data, performing measurements at a number of effective measurement channels of 25,000, and analyzing the measurement data.

A solution obtained by dissolving special grade sodium chloride in ion-exchanged water to a concentration of about 1% by mass, for example, “ISOTON II” (produced by Beckman Coulter Inc.), can be used as the aqueous electrolytic solution to be used in the measurement.

The dedicated software is set as described hereinbelow before the measurement and analysis are performed.

At the “STANDARD MEASUREMENT METHOD (SOM) CHANGE SCREEN” of the dedicated software, the total count number of a control mode is set to 50,000 particles, the number of measurement cycles is set to 1, and a value obtained using “STANDARD PARTICLES 10.0 μm” (produced by Beckman Coulter Inc.) is set as a Kd value. A threshold and a noise level are set automatically by pressing a threshold/noise level measurement button. Further, a current is set to 1600 μA, a gain is set to 2, an electrolytic solution is set to ISOTON II, and a check mark is placed in “FLUSH OF APERTURE TUBE AFTER MEASUREMENT” check box.

At the “PULSE-TO-PARTICLE DIAMETER CONVERSION SETTING SCREEN” of the dedicated software, a bin interval is set to a logarithmic particle diameter, the number of particle diameter bins is set to 256, and the particle diameter range is set to a range from 2 μm to 60 μm.

A specific measurement method is described below.

(1) About 200.0 ml of the aqueous electrolytic solution is poured into a 250-mL round-bottom beaker designed specifically for Multisizer 3. The beaker is set in a sample stand, and the aqueous electrolytic solution is stirred with a stirrer rod at 24 rotations/sec in a counterclockwise direction. Then, dirt and air bubbles in the aperture tube are removed by the “FLUSH APERTURE TUBE” function of the dedicated software.

(2) About 30 mL of the aqueous electrolytic solution is poured into a 100-mL flat-bottom glass beaker. Then, about 0.3 mL of a diluted solution prepared by diluting “Contaminon N” (a 10% by mass aqueous solution of a neutral detergent for washing precision measuring devices; includes a nonionic surfactant, an anionic surfactant, and an organic builder, and has a pH of 7; produced by Wako Pure Chemical Industries, Ltd.) with ion-exchanged water by a factor of 3 in terms of mass is added as a dispersant to the aqueous electrolytic solution.

(3) A predetermined amount of ion-exchanged water is poured into the water tank of an ultrasonic dispersing unit “Ultrasonic Dispersion System Tetora 150” (produced by Nikkaki Bios Co., Ltd.) which has an electrical output of 120 W and in which two oscillators each having an oscillating frequency of 50 kHz are installed with a phase shift of 180 degrees, and about 2 mL of the Contaminon N is added to the water tank.

(4) The beaker in clause (2) above is set in the beaker fixing hole of the ultrasonic dispersing unit, and the ultrasonic dispersing unit is actuated. Then, the height position of the beaker is adjusted to realize a maximum resonant state of the liquid level of the aqueous electrolytic solution in the beaker.

(5) About 10 mg of the toner is added by small portions and dispersed in the aqueous electrolytic solution in the beaker of clause (4) above while irradiating the aqueous electrolytic solution with ultrasonic waves. Then, the ultrasonic dispersion treatment is further continued for 60 sec. During the ultrasonic dispersion, the temperature of water in the water tank is appropriately adjusted to be in the range of at least 10° C. and not more than 40° C.

(6) The aqueous electrolytic solution of clause (5) above, in which the toner has been dispersed, is added dropwise with a pipette into the round-bottom beaker of clause (1) above which has been placed in the sample stand, and the measurement concentration is adjusted to about 5%. Measurements are then performed until the number of measured particles becomes 50,000.

(7) The measurement data are analyzed with the dedicated software included with the device, and the weight average particle diameter (D4) is calculated. The “AVERAGE DIAMETER” on the analysis/volume statistics (arithmetic average) screen when the dedicated software is set to graph/% by volume is the weight average particle diameter (D4).

<Method for Measuring Peak Temperature of Maximum Endothermic Peak of Wax and Crystalline Polyester Resin>

The peak temperature of the maximum endothermic peak of wax and crystalline polyester resin is measured using a differential scanning calorimeter “Q1000” (produced by TA Instruments, Inc.) according to ASTM D 3418-82.

The melting points of indium and zinc are used for temperature correction of the detection unit of the device, and the heat of fusion of indium is used for correction of the calorific value.

Specifically, about 5 mg of the sample is accurately weighed and placed in an aluminum pan, and an empty aluminum pan is used as a reference.

The measurement is performed at a ramp rate of 10° C./min in the temperature range of at least 30° C. and not more than 200° C.

In the measurement, the temperature is raised to 200° C. and then the temperature is lowered to 30° C. Thereafter, the temperature is raised again from 30° C. to 200° C. at a ramp rate of 10° C./min.

The peak temperature of the maximum endothermic peak in the DSC curve of this second temperature rise process is taken as the peak temperature of the maximum endothermic peak of the sample.

<Method for Measuring X-Ray Diffraction>

For the X-ray diffraction measurement, a measurement device “RINT-TTRII” (manufactured by Rigaku Corporation) and control software and analysis software supplied with the device are used.

The measurement conditions are presented hereinbelow.

X-ray: Cu/50 kV/300 mA
Goniometer: rotor horizontal goniometer (TTR-2)
Attachment: standard sample holder
Divergence slit: release
Divergence vertical restriction slit: 10.00 mm
Scattering slit: opening
Receiving slit: opening
Counter: scintillation counter
Scan mode: continuous
Scan speed: 4.0000°/min
Sampling width: 0.0200°
Scanning axis: 2θ/θ
Scanning range: 10.0000° to 40.0000°

Subsequently, the toner is set on the sample plate and measurement is started.

In the CuKα characteristic X-ray, the Bragg angle is taken as θ and the diffraction angle is taken as 2θ, and an X-ray diffraction spectrum in which the diffraction angle 2θ is plotted against the abscissa and the X-ray intensity is plotted against the ordinate is obtained in a 2θ range of at least 3° and not more than 35°.

A peak width at half intensity of the X-ray intensity of the diffraction peak in the diffraction peak present in a 2θ range of at least 5.0° and not more than 6.0° in the obtained X-ray diffraction spectrum is taken as a full width at half maximum.

When there is a plurality of diffraction peaks in this range, a full width at half maximum of the diffraction peak having the largest X-ray intensity is determined.

### EXAMPLES

Hereinafter, the present invention will be described in greater detail with reference to Production Examples and Examples, but these place absolutely no limitation on the present invention. Further, the number of parts and percentages in Formulations hereinbelow are all on a mass basis unless otherwise specified.

### Production Example of Compound 1-1

A compound represented by

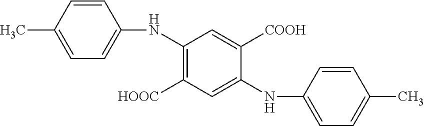

was cyclized in phosphoric acid to produce 2,9-dimethylquinacridone.

Phosphoric acid having 2,9-dimethylquinacridone was dispersed in water, and 2,9-dimethylquinacridone was then filtered off to prepare crude 2,9-dimethylquinacridone (C. I. Pigment Red 122) moistened with water. Further, a compound represented by

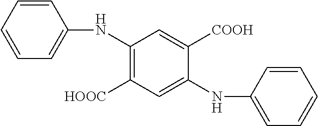 [SMILES: O=C(O)c1cc(Nc2ccccc2)c(C(=O)O)cc1Nc1ccccc1]

was cyclized in phosphoric acid to produce an unsubstituted quinacridone.

Phosphoric acid having the unsubstituted quinacridone was dispersed in water, and the unsubstituted quinacridone was then filtered off to prepare a crude unsubstituted quinacridone (C. I. Pigment Violet 19) moistened with water.

A total of 80 parts of the crude 2,9-dimethylquinacridone and 20 parts of the crude unsubstituted quinacridone were added to a vessel equipped with a condenser and having a mixture of 600 parts of water and 300 parts of ethanol, and the mixture was heated and refluxed for 5 h while grinding the 2,9-dimethyl quinacridone and the unsubstituted quinacridone.

After cooling, the solid-solution pigment was separated by filtration, washed, and redispersed again in 2000 parts of water, and a sodium abietate aqueous solution was added. After thorough stirring, a calcium chloride aqueous solution was added, heat treatment was performed at 90° C. under stirring, and filtration and washing were repeatedly performed, followed by drying. Subsequent pulverization produced a compound 1-1 which is a quinacridone solid-solution pigment treated with a rosin compound.

### Production Examples of Compounds 1-2 and 1-3

Compounds 1-2 and 1-3 were obtained in the same manner as in the production example of compound 1-1 except for changing the mixing mass ratio (compound α: compound β) of 2,9-dimethylquinacridone (compound α) and unsubstituted quinacridone (compound β) as shown in Table 1.

### Production Example of Compound 1-4

Crude 2,9-dimethylquinacridone (C. I. Pigment Red 122) moistened with water was prepared in the same manner as in the production example of compound 1-1.

A total of 100 parts of the crude 2,9-dimethylquinacridone was added to a vessel equipped with a condenser and having a mixture of 600 parts of water and 300 parts of ethanol, and the mixture was heated and refluxed for 5 h while grinding the 2,9-dimethylquinacridone.

After cooling, the pigment was separated by filtration, washed, and redispersed again in 2000 parts of water, and a sodium abietate aqueous solution was added. After thorough stirring, a calcium chloride aqueous solution was added, heat treatment was performed at 90° C. under stirring, and filtration and washing were repeatedly performed, followed by drying. Subsequent pulverization produced a compound 1-4 which is a quinacridone pigment treated with a rosin compound.

### Production Examples of Compounds 1-5 and 1-6

Compounds 1-5 and 1-6 were obtained in the same manner as in the production example of compound 1-4 except that the composition of 2,9-dimethylquinacridone was changed as shown in Table 1.

TABLE 1

| Compound | | Compound α | | Compound β | | | Mixing |
|---|---|---|---|---|---|---|---|
| No. | Compound name | X₁ | X₂ | X₁ | X₂ | Crystal state | mass ratio |
| 1-1 | 2,9-Dimethylquinacridone | CH₃ | CH₃ | H | H | Solid solution | 80:20 |
| | Unsubstituted quinacridone | | | | | | |
| 1-2 | 2,9-Dimethylquinacridone | CH₃ | CH₃ | H | H | Solid solution | 60:40 |
| | Unsubstituted quinacridone | | | | | | |
| 1-3 | 2,9-Dimethylquinacridone | CH₃ | CH₃ | H | H | Solid solution | 95:5 |
| | Unsubstituted quinacridone | | | | | | |
| 1-4 | 2,9-Dimethylquinacridone | CH₃ | CH₃ | — | — | Single | — |
| 1-5 | 2,9-Dichloroquinacridone | Cl | Cl | — | — | Single | — |
| 1-6 | Monomethylquinacridone | CH₃ | H | — | — | Single | — |

### Production Example of Compound 2-1

The compound represented by Formula (2) can be synthesized by a known method. The compound represented by Formula (2) was produced by the method described hereinbelow.

A solution of 10 mmol of an aldehyde compound (1) and 10 mmol of a pyridone compound (1) in 50 mL of methanol was stirred at room temperature for 3 days. After completion of the reaction, the solution was diluted with isopropanol and filtered. Thereafter, the temperature was raised to 150° C., held for 5 min, and then lowered to 0° C. at a rate of 10° C./min to obtain a compound 2-1.

### Production Example of Compounds 2-2 to 2-6

Compounds 2-2 to 2-6 were produced in the same manner as in the production example of compound 2-1, except that the compositions of the aldehyde compound and the pyridone compound were changed as shown in Table 2.

TABLE 2

| Compound No. | Aldehyde compound No. | Pyridone compound No. |
|---|---|---|
| 2-1 | 1 | 1 |
| 2-2 | 2 | 1 |
| 2-3 | 3 | 1 |
| 2-4 | 1 | 5 |
| 2-5 | 2 | 5 |
| 2-6 | 3 | 5 |

### Production Example of Binder Resin 1

A total of 76.9 parts (0.167 molar parts; 100 mol % based on the total number of moles of the alcohol component) of polyoxypropylene (2.2)-2,2-bis(4-hydroxyphenyl)propane, 24.1 parts (0.145 molar parts) of terephthalic acid, 8.0 parts (0.054 molar parts) of adipic acid, and 0.5 parts of titanium tetrabutoxide were placed in a 4-liter glass four-necked flask, and the flask was placed in a mantle heater equipped with a thermometer, a stirring rod, a condenser and a nitrogen introducing tube.

Next, the interior of the flask was replaced with nitrogen gas, the temperature was then gradually raised under stirring, and the reaction was carried out for 4 h while stirring at a temperature of 200° C. (first reaction step).

Thereafter, 1.2 parts (0.006 molar parts) of trimellitic anhydride was added, and the mixture was reacted for 1 h at 180° C. (second reaction step) to obtain a binder resin 1 which is an amorphous polyester resin.

The obtained binder resin 1 had an acid value of 5 mg KOH/g and a hydroxyl value of 65 mg KOH/g. The resin had a weight average molecular weight (Mw) of 8,000, a number average molecular weight (Mn) of 3,500, and a peak molecular weight (Mp) of 5,700. Further, the softening temperature (Tm) of the resin was 90° C.

### Production Example of Binder Resin 2

A binder resin 2 was obtained in the same manner as in the production example of binder resin 1, except that the material of the alcohol component in the production example of binder resin 1 was changed as shown in Table 3.

TABLE 3

| Binder | Alcohol component | | | | Acid value | Hydroxyl value | | | | Tm |
|---|---|---|---|---|---|---|---|---|---|---|
| resin No. | Type | mol % | Type | mol % | (mg KOH/g) | (mg KOH/g) | Mw | Mn | Mp | (° C.) |
| 1 | BPA-PO | 100 | BPA-EO | 0 | 5 | 65 | 8000 | 3500 | 5700 | 90 |
| 2 | BPA-PO | 50 | BPA-EO | 50 | 8 | 67 | 7700 | 3400 | 5500 | 91 |

In Table 3, BPA-PO represents polyoxypropylene (2.2)-2,2-bis(4-hydroxyphenyl)propane, and BPA-EO represents polyoxyethylene (2.2)-2,2-bis(4-hydroxyphenyl)propane.

### Production Example of Binder Resin 3

A total of 71.3 parts (0.155 molar parts) of polyoxypropylene (2.2)-2,2-bis(4-hydroxyphenyl)propane, 24.1 parts (0.145 molar parts) of terephthalic acid, and 0.6 parts of titanium tetrabutoxide were placed in a 4-liter glass four-necked flask, and the flask was placed in a mantle heater equipped with a thermometer, a stirring rod, a condenser and a nitrogen introducing tube.

Next, the interior of the flask was replaced with nitrogen gas, the temperature was then gradually raised under stirring, and the reaction was carried out for 2 h while stirring at a temperature of 200° C. (first reaction step).

Thereafter, 5.8 parts (0.030 molar parts) of trimellitic anhydride was added, and the mixture was reacted for 10 h at 180° C. (second reaction step) to obtain a binder resin 3 which is an amorphous polyester resin.

The obtained binder resin 3 had an acid value of 15 mg KOH/g and a hydroxyl value of 7 mg KOH/g. The resin had a weight average molecular weight (Mw) of 200,000, a number average molecular weight (Mn) of 5,000, and a peak molecular weight (Mp) of 10,000. Further, the softening temperature of the resin was 130° C.

### Production Example of Binder Resin 4

| | |
|---|---|
| Styrene | 80.0 parts |
| N-butyl acrylate | 20.0 parts |
| 2,2-Bis(4,4-di-t-butylperoxycyclohexyl)propane | 0.8 parts |

The above components were placed in a four-necked flask, the interior of the container was thoroughly replaced with nitrogen, the temperature was raised to 130° C., and 200 parts of xylene was added dropwise over 3 h under stirring.

Further, polymerization was completed under reflux of xylene, and the solvent was distilled off under reduced pressure to obtain a binder resin 4.

The acid value of the obtained binder resin 4 was less than the detection lower limit.

The glass transition temperature (Tg) of the resin was 56° C.

Further, the resin had a weight average molecular weight (Mw) of 50,000, a number average molecular weight (Mn) of 10,000, a peak molecular weight (Mp) of 18,000, and a softening temperature of 108° C.

### Production Example of Crystalline Polyester Resin 1

| | |
|---|---|
| Hexanediol | 33.9 parts |
| (0.29 mol; 100.0 mol % with respect to the total number of | |
| moles of the polyhydric alcohol) | |
| Dodecanedioic acid | 66.1 parts |
| (0.29 mol; 100.0 mol % with respect to the total number of | |
| moles of the polyvalent carboxylic acid) | |

The above materials were weighed into a flask equipped with a cooling tube, a stirrer, a nitrogen introducing tube, and a thermocouple.

Next, after replacing the interior of the flask with nitrogen gas, the temperature was gradually raised under stirring, and the mixture was reacted for 3 h while stirring at a temperature of 140° C.

Thereafter, 0.5 parts of tin 2-ethylhexanoate was added, the pressure in the flask was lowered to 8.3 kPa, and the reaction was carried out for 4 h while maintaining the temperature at 200° C.

Thereafter, the inside of the flask was depressurized to not more than 5 kPa and the reaction was carried out for 3 h at 200° C. to obtain a crystalline polyester resin 1. In the crystalline polyester resin 1, an endothermic peak derived from the crystal structure was observed.

### Production Example of Crystalline Polyester Resins 2 to 5

Crystalline polyester resins 2 to 5 were obtained by performing the same operations as in the production example of crystalline polyester resin 1 except that the aliphatic diol and aliphatic dicarboxylic acid in the production example of crystalline polyester resin 1 were changed as indicated in Table 4. In the crystalline polyester resins 2 to 5, an endothermic peak derived from the crystal structure was observed.

TABLE 4

| Crystalline | | |
|---|---|---|
| polyester resin No. | Aliphatic diol | Aliphatic dicarboxylic acid |
| 1 | 1,6-Hexanediol | Dodecanedioic acid |
| | (C6) | (C12) |
| 2 | 1,6-Hexanediol | Sebacic acid |
| | (C6) | (C10) |
| 3 | 1,12-Dodecanediol | Sebacic acid |
| | (C12) | (C10) |
| 4 | 1,6-Hexanediol | Fumaric acid |
| | (C6) | (C4) |
| 5 | 1,6-Hexanediol | Tetradecanedioic acid |
| | (C6) | (C14) |

### Production Example of Polymer 1

A total of 300 parts of xylene and 10 parts of hydrocarbon wax (Fischer-Tropsch wax; softening temperature: 90° C.) were placed in an autoclave reaction vessel, which was equipped with a thermometer and a stirrer, and sufficiently dissolved.

After replacing the interior of the reaction vessel with nitrogen, a mixed solution of 68.9 parts of styrene, 7.65 parts of α-methylstyrene, 13.5 parts of cyclohexyl methacrylate, and 250 parts of xylene was added dropwise for 3 h at 180° C. to carry out the polymerization, and the reaction system was further held at this temperature for 30 min. Subsequently, the solvent was removed to obtain a polymer 1.

### Production Examples of Polymers 2 and 3

Polymers 2 and 3 were obtained by performing the same operations except that cyclohexyl methacrylate in the production example of polymer 1 was changed to the compounds indicated in Table 5.

TABLE 5

| | Saturated alicyclic compound used in styrene acrylic resin | |
|---|---|---|
| | | Number of carbon atoms |
| Polymer No. | Compound name | in saturated alicyclic group |
| 1 | Cyclohexyl methacrylate | 6 |
| 2 | Cyclooctyl methacrylate | 8 |
| 3 | Cyclopropyl methacrylate | 3 |

### Production Example of Toner 1

| | |
|---|---|
| Binder resin 1 | 70.0 parts |
| Binder resin 3 | 30.0 parts |
| Crystalline polyester resin 1 | 10.0 parts |
| Fischer-Tropsch wax | 5.0 parts |
| (peak temperature of the maximum endothermic peak: 90° C.) | |
| Polymer 1 | 5.0 parts |
| Compound 1-1 | 9.2 parts |

The above raw materials were mixed using a HENSCHEL MIXER (model FM-75, manufactured by Mitsui Mining Co., Ltd.) at a rotation speed of 20 s⁻¹ and a rotation time of 5 min.

Thereafter, kneading was carried out in a twin-screw kneader (PCM-70 type, manufactured by Ikegai Corp, see the FIGURE) in which the barrel setting temperature of the melt-kneading shaft was set to C0: 30° C., C1: 70° C., C2: 80° C., C3=the barrel setting temperature (Ta) of the kneading portion: 80° C., and C4: 80° C., the rotation speed of the melt-kneading shaft was set to 400 rpm, and the supply amount was set to 20 kg/h.

The temperature of the kneaded material was directly measured using a handy type thermometer HA-200E manufactured by Anritsu Meter Co., Ltd., and it was confirmed that the barrel setting temperature of the melt-kneading shaft agrees with the temperature of the kneaded material in each barrel.

The obtained kneaded material was cooled and coarsely pulverized to not more than 1 mm with a hammer mill to obtain a coarsely pulverized product.

The obtained pulverized product was finely pulverized with a mechanical pulverizer (T-250, manufactured by Turbo Kogyo Co., Ltd.). Further, classification was carried out using a rotary classifier (200TSP, manufactured by Hosokawa Micron Corporation) to obtain toner particles. In addition, the rotation speed of the classifying rotor as the operation condition of the rotary classifier was 50.0 s⁻¹. The weight average particle diameter (D4) of the obtained toner particles was 6.2 μm.

The softening temperature (Tm) of the binder resin constituting the toner particle was 102° C.

A total of 0.8 parts of hydrophobic silica fine particles having a number average particle diameter of primary particles of 10 nm and surface-treated with 20% by mass of hexamethyldisilazane was added to 100.0 parts of the toner particles, and the components were mixed with a HENSCHEL MIXER (model FM-75, manufactured by Mitsui Mining Co., Ltd.) at a rotation speed of 30 s⁻¹ and for a rotation time of 10 min to obtain a toner 1.

### Production Examples of Toners 2 to 16 and 18 to 30

Toners 2 to 16 and 18 to 30 were obtained in the same manner as in the production example of toner 1 except that the melt-kneading conditions (contents of the conditions are shown in Table 6), the type of the binder resin, the type and addition amount of the crystalline polyester resin, the type of the compound, and the type of the polymer in the production example of toner 1 were changed as indicated in Table 7.

In toner 2, the binder resin 2 was used instead of the binder resin 3.

### Production Example of Toner 17

### (Preparation of Dispersed Solution of Binder Resin)

Binder resins 1 and 3 were compounded with 80% ion-exchanged water at a composition ratio such that the concentration of the binder resin 1 was 14% and the concentration of the binder resin 3 was 6%, the pH was adjusted to 8.5 with ammonia, and CAVITRON was operated under the heating condition of 150° C. to obtain a dispersed solution (solid fraction: 20%) of the binder resins 1 and 3.

### (Preparation of Dispersed Solution of Crystalline Polyester Resin)

A total of 80 parts of the crystalline polyester resin 5 and 720 parts of ion-exchanged water were placed in a stainless steel beaker and heated to 99° C. When the crystalline polyester resin 5 was melted, it was stirred using a homogenizer. Subsequently, 2.0 parts of an anionic surfactant (NEOGEN RK, solid fraction: 20%, manufactured by DKS Co., Ltd.) was added dropwise while emulsifying and dispersing to obtain a dispersed solution of the crystalline polyester resin 5 (solid fraction: 10%).

(Preparation of Compound-Dispersed Solution)

| | |
|---|---|
| Compound 1-4 | 1000 parts |
| Anionic surfactant | 150 parts |
| Ion-exchanged water | 9000 parts |

The abovementioned components were mixed and dissolved, and then dispersed using a high-pressure impact-type dispersing machine.

The volume average particle diameter (D50) of the compound particles in the resulting compound-dispersed solution was 0.16 μm, and the concentration of the compound was 23%.

(Preparation of Wax-Dispersed Solution)

| | |
|---|---|
| Fischer Tropsch wax | 45 parts |
| (Peak temperature of maximum endothermic peak 90° C.) | |
| Anionic surfactant | 5 parts |
| Ion-exchanged water | 150 parts |

The abovementioned components were heated to 95° C., dispersed using a homogenizer, and then dispersed using a pressure discharge-type Gaulin homogenizer to prepare a wax-dispersed solution (wax concentration: 20%) in which wax particles having a volume average particle diameter (D50) of 210 nm were dispersed.

| | |
|---|---|
| Dispersed solution of binder resins 1 and 3 | 500.0 parts |
| Dispersed solution of crystalline polyester resin 5 | 100.0 parts |
| Colorant-dispersed solution | 30.5 parts |
| Wax-dispersed solution | 25.0 parts |
| 1.5% by mass magnesium sulfate aqueous solution | 50.0 parts |

The abovementioned materials were dispersed using a homogenizer (ULTRA TURRAX T50, manufactured by IKA®-Werke GmbH & Co. KG). Subsequently, the pH was adjusted to 8.1 with 0.1 mol/L sodium hydroxide aqueous solution.

Thereafter, the mixture was heated to 45° C. in a heating water bath under stirring with a stirring blade. After holding at 45° C. for 1 h, observation with an optical microscope confirmed that aggregated particles having an average particle diameter of about 5.5 μm were formed.

After adding 40.0 parts of a 5% by mass aqueous solution of trisodium citrate, the temperature was raised to 85° C. and kept for 120 min while stirring was continued to fuse the resin particles.

Subsequently, water was poured in a water bath and cooling to 25° C. was performed while stirring was continued. The particle diameter of the resin particles was measured with a particle size distribution analyzer (Coulter Multisizer III: manufactured by Coulter Corporation) according to a Coulter method, and the volume-based median diameter was 5.5 μm.

Thereafter, after filtration and solid-liquid separation, 800.0 parts of ion-exchanged water with a pH adjusted to 8.0 with the sodium hydroxide was added to the solid fraction, followed by stirring and washing for 30 min.

Thereafter, filtration and solid-liquid separation were performed again. Subsequently, 800.0 parts of ion-exchanged water was added to the solid fraction, followed by stirring and washing for 30 min. Thereafter, filtration and solid-liquid separation were performed again, and this was repeated five times.

Next, the obtained solid fraction was dried to obtain toner particles.

A total of 0.8 parts of hydrophobic silica fine particles having a number average particle diameter of primary particles of 10 nm and surface-treated with 20% by mass of hexamethyldisilazane was added to 100.0 parts of the resultant toner particles, and the components were mixed with a HENSCHEL MIXER (model FM-75, manufactured by Mitsui Mining Co., Ltd.) at a rotation speed of 30 s⁻¹ and for a rotation time of 10 min to obtain a toner 17.

In DSC measurement of Toner 17, an endothermic peak derived from the crystalline resin was observed.

### Production Example of Toner 31

A toner 31 was obtained in the same manner as in the production example of toner 1 except that 100.0 parts of binder resin 4 was used in place of 70.0 parts of binder resin 1 and 30.0 parts of binder resin 3 in the production example of toner 1.

TABLE 6

| | Barrel setting temperature (° C.) | | | | |
|---|---|---|---|---|---|
| | | | | C3 | |
| Melt-kneading | | | | (Kneading portion) | |
| condition No. | C0 | C1 | C2 | Ta (° C.) | C4 |
| 1 | 30 | 70 | 80 | 80 | 80 |
| 2 | 30 | 50 | 75 | 75 | 75 |
| 3 | 30 | 70 | 100 | 100 | 100 |
| 4 | 30 | 70 | 90 | 90 | 90 |

Regarding C0, C1, C2, C3 and C4 in Table 6, see the FIGURE.

TABLE 7

| | | | | | | | | | | | | | X-ray |
|---|---|---|---|---|---|---|---|---|---|---|---|---|---|
| | | | | | | | | | | | | | diffraction |
| | | | | | | Crystalline | | | | | | | peak |
| | Compound 1 | | Compound 2 | | | polyester resin | | | Melt- | | | | Full width |
| | | Addition | | Addition | Binder | | Addition | | kneading | | | | at half |
| Toner | | amount | | amount | resin | | amount | Polymer | condition | Tm | Ta | Tm − Ta | maximum |
| No. | No. | (parts) | No. | (parts) | No. | No. | (parts) | No. | No. | (° C.) | (° C.) | (° C.) | (°) |
| 1 | 1 | 9.2 | — | — | 1, 3 | 1 | 10.0 | 1 | 1 | 102 | 80 | 22 | 0.422 |
| 2 | 1 | 9.2 | — | — | 1, 2 | 1 | 10.0 | 1 | 1 | 103 | 80 | 23 | 0.419 |
| 3 | 1 | 9.2 | — | — | 1, 3 | 1 | 10.0 | 2 | 1 | 102 | 80 | 22 | 0.421 |
| 4 | 1 | 9.2 | — | — | 1, 3 | 1 | 10.0 | 3 | 1 | 102 | 80 | 22 | 0.417 |
| 5 | 1 | 9.2 | — | — | 1, 3 | 2 | 10.0 | 3 | 1 | 102 | 80 | 22 | 0.416 |
| 6 | 1 | 9.2 | — | — | 1, 3 | 3 | 10.0 | 3 | 1 | 102 | 80 | 22 | 0.425 |
| 7 | 1 | 9.2 | — | — | 1, 3 | 4 | 10.0 | 3 | 1 | 102 | 80 | 22 | 0.414 |
| 8 | 1 | 9.2 | — | — | 1, 3 | 5 | 10.0 | 3 | 1 | 102 | 80 | 22 | 0.418 |
| 9 | 2 | 9.2 | — | — | 2, 3 | 5 | 10.0 | 3 | 1 | 102 | 80 | 22 | 0.428 |
| 10 | 3 | 9.2 | — | — | 1, 3 | 5 | 10.0 | 3 | 1 | 102 | 80 | 22 | 0.412 |
| 11 | 4 | 9.2 | — | — | 1, 3 | 5 | 10.0 | 3 | 1 | 102 | 80 | 22 | 0.411 |
| 12 | 5 | 9.2 | — | — | 1, 3 | 5 | 10.0 | 3 | 1 | 102 | 80 | 22 | 0.431 |
| 13 | 6 | 9.2 | — | — | 1, 3 | 5 | 10.0 | 3 | 1 | 102 | 80 | 22 | 0.416 |
| 14 | 4 | 9.2 | — | — | 1, 3 | 5 | 10.0 | — | 1 | 102 | 80 | 22 | 0.410 |
| 15 | 4 | 9.2 | — | — | 1, 3 | 5 | 10.0 | 3 | 2 | 102 | 75 | 27 | 0.438 |
| 16 | 4 | 9.2 | — | — | 1, 3 | 5 | 10.0 | 3 | 3 | 102 | 100 | 2 | 0.402 |
| 17 | 4 | 9.2 | — | — | 1, 3 | 5 | 10.0 | 3 | *a | 90 | — | — | 0.405 |
| 18 | 1 | 8.0 | 1 | 1.2 | 1, 3 | 1 | 10.0 | 1 | 1 | 102 | 80 | 22 | 0.423 |
| 19 | 1 | 8.0 | 1 | 1.2 | 1, 3 | 1 | 10.0 | — | 1 | 102 | 80 | 22 | 0.418 |
| 20 | 1 | 8.0 | 1 | 1.2 | 1, 3 | 2 | 10.0 | — | 1 | 102 | 80 | 22 | 0.417 |
| 21 | 1 | 8.0 | 1 | 1.2 | 1, 3 | 3 | 10.0 | — | 1 | 102 | 80 | 22 | 0.422 |
| 22 | 1 | 8.0 | 1 | 1.2 | 1, 3 | 4 | 10.0 | — | 1 | 102 | 80 | 22 | 0.419 |
| 23 | 1 | 8.0 | 1 | 1.2 | 1, 3 | 5 | 10.0 | — | 1 | 102 | 80 | 22 | 0.421 |
| 24 | 1 | 8.0 | 2 | 1.2 | 1, 3 | 5 | 10.0 | — | 1 | 102 | 80 | 22 | 0.422 |
| 25 | 1 | 8.0 | 3 | 1.2 | 1, 3 | 5 | 10.0 | — | 1 | 102 | 80 | 22 | 0.426 |
| 26 | 1 | 8.0 | 4 | 1.2 | 1, 3 | 5 | 10.0 | — | 1 | 102 | 80 | 22 | 0.427 |
| 27 | 1 | 8.0 | 5 | 1.2 | 1, 3 | 5 | 10.0 | — | 1 | 102 | 80 | 22 | 0.427 |
| 28 | 1 | 8.0 | 6 | 1.2 | 1, 3 | 5 | 10.0 | — | 1 | 102 | 80 | 22 | 0.418 |
| 29 | 1 | 9.2 | — | — | 1, 3 | — | — | 1 | 1 | 102 | 80 | 22 | 0.355 |
| 30 | 1 | 9.2 | — | — | 1, 3 | 1 | 3.0 | 1 | 1 | 102 | 80 | 22 | 0.385 |
| 31 | 1 | 9.2 | — | — | 4 | 1 | 10.0 | 1 | 4 | 108 | 90 | 18 | 0.458 |

In Table 7, *a indicates that the method for producing the toner particles is an emulsion aggregation method.

### Production Example of Magnetic Core Particle 1

Step 1 (Weighing and Mixing Step):

| | |
|---|---|
| Fe₂O₃ | 62.7 parts |
| MnCO₃ | 29.5 parts |
| Mg(OH)₂ | 6.8 parts |
| SrCO₃ | 1.0 parts |

Ferrite raw materials were weighed so as to obtain the abovementioned composition ratio of the materials. Thereafter, the mixture was pulverized and mixed for 5 h with a dry vibration mill by using stainless steel beads having a diameter of ⅛ inches.

Step 2 (Pre-Calcination Step):

The pulverized product thus obtained was made into square pellets with a side of about 1 mm by a roller compactor. The pellets were subjected to removal of coarse powder with a vibration sieve having an opening of 3 mm, then fine powder was removed with a vibration sieve having an opening of 0.5 mm, and then the burner-type calcination furnace was used to carry out calcination for 4 h at a temperature of 1000° C. under a nitrogen atmosphere (oxygen concentration: 0.01% by volume) to prepare a pre-calcined ferrite. The composition of the obtained pre-calcined ferrite is as follows.

(MnO)ₐ(MgO)_{b}(SrO)_{c}(Fe₂O₃)_{d}

In the above formula, a=0.257, b=0.117, c=0.007, and d=0.393.

Step 3 (Pulverization Step)

The pre-calcined ferrite was pulverized to about 0.3 mm with a crusher, then 30 parts of water was added to 100 parts of the pre-calcined ferrite, and pulverization was carried out for 1 h with a wet ball mill by using zirconia beads having a diameter of ⅛ inches. The obtained slurry was pulverized for 4 h with a wet ball mill using alumina beads having a diameter of 1/16 inches to obtain ferrite slurry (finely pulverized product of pre-calcined ferrite).

Step 4 (Granulation Step):

A total of 1.0 parts of ammonium polycarboxylate as a dispersant and 2.0 parts of polyvinyl alcohol as a binder resin were added, with respect to 100 parts of the pre-calcined ferrite, to the ferrite slurry, followed by granulation into spherical particles with a spray dryer (manufacturer: Okawara Kakohki Co., Ltd.). After adjusting the particle size of the obtained particles, the organic components of the dispersant and the binder resin were removed by heating for 2 h at 650° C. by using a rotary kiln.

Step 5 (Calcination Step):

In order to control the calcination atmosphere, the temperature was raised over 2 h from room temperature to a temperature of 1300° C. under a nitrogen atmosphere (oxygen concentration 1.00% by volume) in an electric furnace, and then calcination was carried out for 4 h at a temperature of 1150° C. The temperature was then lowered to 60° C. over 4 h, the atmosphere was returned from the nitrogen atmosphere to the air atmosphere, and the product was taken out at a temperature of not more than 40° C.

Step 6 (Screening Step):

After crushing the aggregated particles, the low-magnetic-force products were cut by magnetic separation and coarse particles were removed by sieving with a 250 μm mesh sieve to obtain magnetic core particles 1 with a 50% particle size (D50) based on volume distribution of 37.0 μm.

<Preparation of Coating Resin 1>

| | |
|---|---|
| Cyclohexyl methacrylate monomer | 26.8% by mass |
| Methyl methacrylate monomer | 0.2% by mass |
| Methyl methacrylate macromonomer | 8.4% by mass |
| (a macromonomer having a methacryloyl group at one | |
| end and a weight average molecular weight of 5000) | |
| Toluene | 31.3% by mass |
| Methyl ethyl ketone | 31.3% by mass |
| Azobisisobutyronitrile | 2.0% by mass |

Among the abovementioned materials, cyclohexyl methacrylate monomer, methyl methacrylate monomer, methyl methacrylate macromonomer, toluene, and methyl ethyl ketone were added to a four-necked separable flask equipped with a reflux condenser, a thermometer, a nitrogen introducing tube and a stirrer, and nitrogen gas was introduced to obtain a sufficiently nitrogen atmosphere.

Thereafter, the mixture was heated to 80° C., azobisisobutyronitrile was added, and the mixture was refluxed for 5 h for polymerization. Hexane was injected into the obtained reaction product to cause sedimentation and precipitation of the copolymer, and the precipitate was filtered off and vacuum dried to obtain a coating resin 1. A total of 30 parts of the coating resin 1 thus obtained was dissolved in a mixture of 40 parts of toluene and 30 parts of methyl ethyl ketone to obtain a polymer solution 1 (solid fraction: 30% by mass).

<Preparation of Coating Resin Solution 1>

| | |
|---|---|
| Polymer solution 1 (resin solid fraction concentration: | 33.3% by mass |
| 30%) | |
| Toluene | 66.4% by mass |
| Carbon black (Regal 330; manufactured by Cabot | 0.3% by mass |
| Corporation) | |
| (primary particle diameter 25 nm, nitrogen adsorption | |
| specific surface area: 94 m²/g, DBP oil absorption | |
| amount: 75 mL/100 g) | |

The above materials were dispersed for 1 h with a paint shaker using zirconia beads having a diameter of 0.5 mm. The resulting dispersed solution was filtered with a membrane filter of 5.0 μm to obtain a coating resin solution 1.

### Production Example of Magnetic Carrier 1

### (Resin Coating Step):

The coating resin solution 1 was charged into a vacuum degassing kneader maintained at room temperature in an amount of 2.5 parts as a resin component per 100 parts of magnetic core particles 1. After charging, the mixture was stirred for 15 min at a rotation speed of 30 rpm, and the solvent was volatilized to a certain level or more (80% by mass).

Thereafter, the temperature was raised to 80° C. while mixing under reduced pressure, and toluene was distilled off over 2 h, followed by cooling. The obtained magnetic carrier was screened by magnetic separation to cut a low-magnetic-force product and then passed through a sieve having an opening of 70 μm and classified with a wind power classifier to obtain a magnetic carrier 1 having a 50% particle diameter (D50) based on the volume distribution of 38.2 μm.

### Examples 1 to 28 and Comparative Examples 1 to 3

The toner 1 and the magnetic carrier 1 were compounded so that the toner concentration became 9% by mass, and mixed for 5 min at a speed of 0.5 s⁻¹ by using a V-type mixer (V-10 type: Tokuju Corporation.) to obtain a two-component developer 1.

Further, two-component developers 2 to 31 were obtained by changing the combination of toner and magnetic carrier as shown in Table 8. The two-component developers of Examples 1 to 28 and Comparative Examples 1 to 3 were then evaluated in the following manner. The evaluation results of Examples 1 to 28 and Comparative Examples 1 to 3 are shown in Table 9.

TABLE 8

| | Toner | Magnetic | Two-component |
|---|---|---|---|
| | No. | carrier No. | developer No. |
| Example 1 | 1 | 1 | 1 |
| Example 2 | 2 | 1 | 2 |
| Example 3 | 3 | 1 | 3 |
| Example 4 | 4 | 1 | 4 |
| Example 5 | 5 | 1 | 5 |
| Example 6 | 6 | 1 | 6 |
| Example 7 | 7 | 1 | 7 |
| Example 8 | 8 | 1 | 8 |
| Example 9 | 9 | 1 | 9 |
| Example 10 | 10 | 1 | 10 |
| Example 11 | 11 | 1 | 11 |
| Example 12 | 12 | 1 | 12 |
| Example 13 | 13 | 1 | 13 |
| Example 14 | 14 | 1 | 14 |
| Example 15 | 15 | 1 | 15 |
| Example 16 | 16 | 1 | 16 |
| Example 17 | 17 | 1 | 17 |
| Example 18 | 18 | 1 | 18 |
| Example 19 | 19 | 1 | 19 |
| Example 20 | 20 | 1 | 20 |
| Example 21 | 21 | 1 | 21 |
| Example 22 | 22 | 1 | 22 |
| Example 23 | 23 | 1 | 23 |
| Example 24 | 24 | 1 | 24 |
| Example 25 | 25 | 1 | 25 |
| Example 26 | 26 | 1 | 26 |
| Example 27 | 27 | 1 | 27 |
| Example 28 | 28 | 1 | 28 |
| Comparative | 29 | 1 | 29 |
| Example 1 | | | |
| Comparative | 30 | 1 | 30 |
| Example 2 | | | |
| Comparative | 31 | 1 | 31 |
| Example 3 | | | |

<Method for Evaluating Tinting Strength of Toner>

A full-color copying machine imageRUNNER ADVANCE C5255 manufactured by Canon Inc. was used as an image forming apparatus, a two-component developer was loaded in a developing device of a magenta station, and evaluation was performed.

The evaluation environment was set to normal temperature and normal humidity (23° C., 50% RH), and the evaluation paper was copy plain paper CS-680 (A4 paper, basis weight: 68 g/m², sold by Canon Marketing Japan Inc.).

First, in the evaluation environment, image output was performed in a state in which the developing bias was constant, and the image density of the output image was examined.

The image density was measured using an X-Rite color reflection densitometer (500 series: manufactured by X-Rite Inc.).

From the results of the X-Rite color reflection densitometer, the tinting strength of the toner was evaluated according to the following criteria. The evaluation results are shown in Table 9.

### (Evaluation Criteria)

A: at least 1.30
B: at least 1.25 and less than 1.30
C: at least 1.20 and less than 1.25
D: less than 1.20

<Method for Evaluating Lightness, Chroma, and Changing in Tinges of Toner>

A full-color copying machine imageRUNNER ADVANCE C5255 manufactured by Canon Inc. was used as an image forming apparatus, a two-component developer was loaded in a developing device of a magenta station, and evaluation was performed.

The evaluation environment was set to normal temperature and normal humidity (23° C., 50% RH), and the evaluation paper was copy plain paper CS-680 (A4 paper, basis weight: 68 g/m², sold by Canon Marketing Japan Inc.).

First, in the evaluation environment, the relationship between the image density and the toner laid-on level on the paper was examined by changing the amount of the toner laid-on level on the paper.

Next, the image density of a FFH image (solid portion) was adjusted to 1.40, and a solid image was outputted.

L₁*, a₁*, b₁* of the solid image were measured using SpectroScan Transmission (manufactured by Gretag Macbeth GmbH) (measurement condition: D₅₀, viewing angle 2°).

The larger the L₁*, the higher the lightness, and the evaluation was carried out according to the following criteria. The evaluation results are shown in Table 9.

### (Evaluation Criteria)

A: at least 54.0
B: at least 52.0 and less than 54.0
C: at least 50.0 and less than 52.0
D: less than 50.0

Further, C₁* of each gradation was obtained from the following formula.

C₁*={(a₁*)²+(b₁*)²}^{0.5}

The larger C₁*, the higher the chroma, and the evaluation was carried out according to the following criteria. The evaluation results are shown in Table 9.

(Evaluation criteria)
A: at least 70.0
B: at least 65.0 and less than 70.0
C: at least 60.0 and less than 65.0
D: less than 60.0

Next, in an image with a print percentage of 1%, a fixed amount of the toner was added to make the toner concentration constant, and 5000 (5 k) images were outputted.

After the end of the 5 k durability output, the relationship between the image density and the toner laid-on level on the paper was examined by changing the amount of the toner laid-on level on the paper.

Next, the image density of a FFH image (solid portion) was adjusted to 1.40, and a solid image was outputted.

L₂*, a₂*, b₂* of the solid image were measured using SpectroScan Transmission (manufactured by Gretag Macbeth GmbH) (measurement condition: D₅₀, viewing angle 2°).

ΔE was calculated from the values of L*, a*, and b* of the initial image and the image after the 5 k durability output. The evaluation results are shown in Table 9.

ΔE={(L₁*−L₂*)²(a₁*−a₂*)²(b₁*−b₂*)²}^{0.5}

(Evaluation criteria)
A: ΔE is small, and a changing in tinges cannot be confirmed visually
B: ΔE is larger than the evaluation “A”, but a changing in tinges cannot be confirmed visually
C: ΔE is larger than the evaluation “B”, but only slight changing in tinges can be confirmed visually
D: ΔE is larger than the evaluation “C”, and a changing in tinges can be confirmed visually

TABLE 9

| | Tinting strength | | | | | | | |
|---|---|---|---|---|---|---|---|---|
| | Image | | Lightness | | Chroma | | Changing in tinges | |
| | density | Rank | L1* | Rank | C1* | Rank | ΔE | Rank |
| Example 1 | 1.33 | A | 54.2 | A | 71.3 | A | 0.2 | A |
| Example 2 | 1.34 | A | 54.4 | A | 70.6 | A | 0.3 | A |
| Example 3 | 1.34 | A | 54.2 | A | 71.1 | A | 0.3 | A |
| Example 4 | 1.32 | A | 54.0 | A | 71.0 | A | 0.2 | A |
| Example 5 | 1.33 | A | 53.8 | B | 70.5 | A | 0.2 | A |
| Example 6 | 1.32 | A | 53.5 | B | 70.8 | A | 0.3 | A |
| Example 7 | 1.32 | A | 53.4 | B | 70.6 | A | 0.3 | A |
| Example 8 | 1.32 | A | 53.1 | B | 70.2 | A | 0.3 | A |
| Example 9 | 1.31 | A | 53.2 | B | 70.3 | A | 0.4 | B |
| Example 10 | 1.30 | A | 52.8 | B | 68.7 | B | 0.6 | B |
| Example 11 | 1.28 | B | 52.5 | B | 67.9 | B | 0.7 | B |
| Example 12 | 1.29 | B | 52.4 | B | 67.2 | B | 0.6 | B |
| Example 13 | 1.27 | B | 52.4 | B | 66.1 | B | 0.6 | B |
| Example 14 | 1.27 | B | 52.1 | B | 66.4 | B | 0.6 | B |
| Example 15 | 1.27 | B | 52.0 | B | 63.3 | C | 0.6 | B |
| Example 16 | 1.26 | B | 51.5 | C | 66.4 | B | 0.8 | B |
| Example 17 | 1.28 | B | 52.2 | B | 61.5 | C | 1.3 | C |
| Example 18 | 1.34 | A | 54.5 | A | 72.2 | A | 0.2 | A |
| Example 19 | 1.29 | B | 54.3 | A | 72.0 | A | 0.3 | A |
| Example 20 | 1.27 | B | 54.2 | A | 71.7 | A | 0.3 | A |
| Example 21 | 1.26 | B | 54.4 | A | 71.9 | A | 0.4 | B |
| Example 22 | 1.27 | B | 54.1 | A | 71.6 | A | 0.3 | A |
| Example 23 | 1.27 | B | 54.4 | A | 70.8 | A | 0.4 | B |
| Example 24 | 1.26 | B | 53.9 | B | 71.2 | A | 0.5 | B |
| Example 25 | 1.28 | B | 53.7 | B | 70.7 | A | 0.6 | B |
| Example 26 | 1.27 | B | 53.6 | B | 71.1 | A | 0.5 | B |
| Example 27 | 1.26 | B | 53.5 | B | 70.5 | A | 0.7 | B |
| Example 28 | 1.27 | B | 52.8 | B | 70.6 | A | 1.2 | C |
| Comparative | 1.25 | B | 49.1 | D | 57.2 | D | 2.1 | D |
| Example 1 | | | | | | | | |
| Comparative | 1.26 | B | 49.6 | D | 59.3 | D | 1.6 | C |
| Example 2 | | | | | | | | |
| Comparative | 1.24 | C | 48.8 | D | 59.5 | D | 3.7 | D |
| Example 3 | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-089856, filed, Apr. 28, 2017, and Japanese Patent Application No. 2018-055535, filed, Mar. 23, 2018, which are hereby incorporated by reference herein in their entirety.

What is claimed is:

1. A toner comprising a toner particle including a binder resin and a colorant, wherein
the colorant includes a compound represented by Formula (1) below, and
a crystal of the compound in the toner particle has a diffraction peak with a full width at half maximum of at least 0.400° and not more than 0.440° in a range of a diffraction angle 2θ of at least 5.0° and not more than 6.0° in an X-ray diffraction spectrum using CuKα rays: 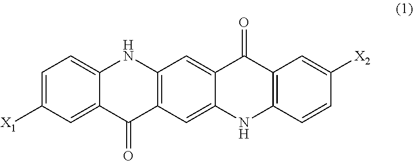
in Formula (1), X₁ and X₂ each independently represent a hydrogen atom, a chlorine atom or a methyl group.

2. The toner according to claim 1, wherein the binder resin includes an amorphous polyester resin.

3. The toner according to claim 1, wherein the toner particle includes a crystalline polyester resin.

4. The toner according to claim 3, wherein the crystalline polyester resin is a polycondensate of an alcohol component including at least one compound selected from the group consisting of aliphatic diols having at least 6 and not more than 12 carbon atoms and derivatives thereof, and a carboxylic acid component including at least one compound selected from the group consisting of aliphatic dicarboxylic acids having at least 6 and not more than 12 carbon atoms and derivatives thereof.

5. The toner according to claim 1, wherein the toner particle includes a polymer in which a styrene acrylic resin having a structural moiety derived from a saturated alicyclic compound is graft polymerized to a polyolefin.

6. The toner according to claim 1, wherein the toner particle includes a compound represented by Formula (2) below: 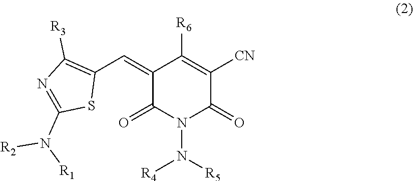
in Formula (2), R₁, R₂, R₃ and R₆ each independently represent an alkyl group having 1 to 20 carbon atoms or an aryl group having 6 to 10 carbon atoms, R₄ and R₅ each independently represent an aryl group having 6 to 10 carbon atoms, an acyl group having 1 to 30 carbon atoms, or an alkyl group having 1 to 20 carbon atoms, or represent a cyclic organic functional group in which R₄ and R₅ are bonded to each other and which includes R₄, R₅, and a nitrogen atom to which R₄ and R₅ are bonded at the same time.

7. A method for producing a toner having a toner particle, the method comprising:
a melt-kneading step of melt-kneading, with a twin-screw extruder, a mixture including a binder resin including an amorphous polyester resin, a colorant including a compound represented by Formula (1) below, and a crystalline polyester resin, wherein
when a barrel setting temperature of a kneading portion of a melt-kneading shaft of the twin-screw extruder in the melt-kneading step is denoted by Ta (° C.) and a softening temperature of the binder resin is denoted by Tm (° C.), the Ta and the Tm satisfy Formula (4) below:
−10≤Tm−Ta≤30 (4) 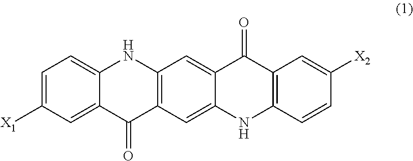
in Formula (1), X₁ and X₂ each independently represent a hydrogen atom, a chlorine atom or a methyl group.
